(19) United States
(12) Patent Application Publication
(10) Pub. No.: US 2006/0130070 A1
(43) Pub. Date: Jun. 15, 2006

(54) System and method of event correlation

(76) Inventor: Lars Oliver Graf, Cotati, CA (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/995,707

(22) Filed: Nov. 22, 2004

(51) Int. Cl. G06F 9/46

(52) U.S. Cl. 719/318

(57) ABSTRACT

What is disclosed is a method of configuring an event correlation system, which includes routing an event stream received from an input of the event correlation system to a filter, processing the event stream through a first correlation algorithm within the filter to provide a correlated output stream, wherein the first correlation algorithm is configurable in response to a first configuration control instruction and routing the correlated output stream to an output of the event correlation system. Additionally, a method of providing an event correlation system which can be integrated into a software system providing a source, filter and destination module is disclosed. Finally, the same method embodied in a computer program product is disclosed.

### FIELD OF THE INVENTION

The present invention relates in general to computer software and, more particularly, to event correlation.

### BACKGROUND OF THE INVENTION

“Events,” or computer generated messages that indicate an occurrence of some kind, are commonplace in today's IT dominated world. In a general sense, every part of a modern network provides information in one form or another. For example, operating systems log systems and security events, servers log events that detail the server's operations, applications log errors, warnings and failures, firewalls and virtual private networks log attempts to gain access, routers and switches log activity that takes place, and messaging systems forward alerts, such as Simple Network Management Protocol (SNMP) traps to a central management console. As a result, a dizzying array of information is generated and disseminated throughout the network. Many network components, besides generating their own information, will relay or forward information received from other network components, resulting in duplicate events being generated. In total, millions of events are generated in any given network during a particular session.

Events, and particularly their number can exponentially increase as a function of the complexity of a given network. For an individual who is tasked to monitor these events, there are far more events generated than can be manually sorted. As a result, event correlation, or the process of mechanically sifting through events to draw a broad-based conclusion, aims to simplify and speed monitoring of events. Event correlation, for example, can reduce the task of sorting through several million events to sorting through a hundred alarms, a fraction of which may actually need action taken.

As event correlation has become more of a necessity, particularly in network and security management, a handful of proprietary architectures to address the need have been developed. In general, these event correlation architectures (1) aggregate, (2) normalize and (3) correlate events using predefined algorithms.

Event correlation architectures have helped to simplify network and security management. However, because each architecture is proprietary, their use, flexibility and scalability are limited to the scope of the original programming. Moreover, these architectures lack consistent organization, an ability to translate across varying protocols, and user interfaces that effectively and efficiently manage the architecture. In addition, these systems are non-modular and non-publishable.

As a result, a need exists for a method and system of implementing event correlation that separates the core architecture from the business logic that runs on its surface. A powerful, flexible and user-friendly interface is needed to integrate an IT administrator with varying degrees of competence with the event correlation system. A more effective method of organization and execution of event correlation is needed to allow for simplification and translation across protocols and applications. Finally, a need exists for a scalable, modular, publishable method and system of event correlation that can be implemented in a variety of applications and settings.

### SUMMARY OF THE INVENTION

In one embodiment, the present invention is a method of configuring an event correlation system, which comprises routing an event stream received from an input of the event correlation system to a filter, processing the event stream through a first correlation algorithm within the filter to provide a correlated output stream, wherein the first correlation algorithm is configurable in response to a first configuration control instruction, and routing the correlated output stream to an output of the event correlation system.

In another embodiment, the present invention is a method of providing an event correlation system which can be integrated into a software system, which comprises providing a source module for routing an event stream received from an input of the event correlation system, providing a filter module for processing the event stream through a first correlation algorithm, the filter module being configurable to operate with the software system, and providing a destination module for routing a correlated output stream from the filter module to an output of the event correlation system.

In another embodiment, the present invention is a method of processing an event stream into a correlated output, which comprises providing a source module to receive the event stream and route the event stream to a filter module and configuring the filter module to process the event stream through a first correlation algorithm to provide the correlated output, the filter module being configurable in response to a first configuration instruction.

In another embodiment, the present invention is a computer program product comprising a computer usable medium having computer readable program code means embodied in said medium for causing an application program to execute on a computer that provides an event correlation system, said computer readable program code which comprises a first computer readable program code means for routing an event stream received from an input of the event correlation system to a filter, a second computer readable program code means for processing the event stream through a first correlation algorithm within the filter to provide a correlated output stream, wherein the first correlation algorithm is configurable in response to a first configuration control instruction and a third computer readable program code means for routing the correlated output stream to an output of the event correlation system.

### BRIEF DESCRIPTION OF THE DRAWINGS

FIG. 1 illustrates a block diagram of a network connected to an event correlation system;

FIG. 2 illustrates a block diagram of the architecture of a computer system;

FIG. 3 illustrates a block diagram of the computer system architecture depicted in FIG. 2;

FIG. 4 illustrates a block diagram of the computer system architecture depicted in FIG. 2;

FIG. 5 illustrates a block diagram of the computer system architecture depicted in FIG. 4;

FIGS. 6a-6l illustrate system objects of the computer system architecture depicted in FIG. 4;

FIGS. 7a-7l further illustrate system objects of the computer system architecture depicted in FIG. 4;

FIGS. 8a-8ss further illustrate system objects of the computer system architecture depicted in FIG. 4;

FIG. 9 illustrates a block diagram of the architecture of a computer application;

FIG. 10 illustrates a block diagram of the computer application depicted in FIG. 6;

FIG. 11 illustrates a block diagram of an example of the computer application depicted in FIG. 6;

FIG. 12a illustrates a possible configuration of an event correlation system on one computer;

FIG. 12b illustrates a possible configuration of an event correlation system on multiple computers;

FIG. 13a illustrates a possible hierarchical configuration of an event correlation system;

FIG. 13b illustrates a possible network configuration of an event correlation system;

FIG. 14 illustrates a possible load balancing configuration of an event correlation system;

FIG. 15 illustrates a graphical user interface of an event correlation system; and

FIG. 16 illustrates a graphical user interface of an event correlation system.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

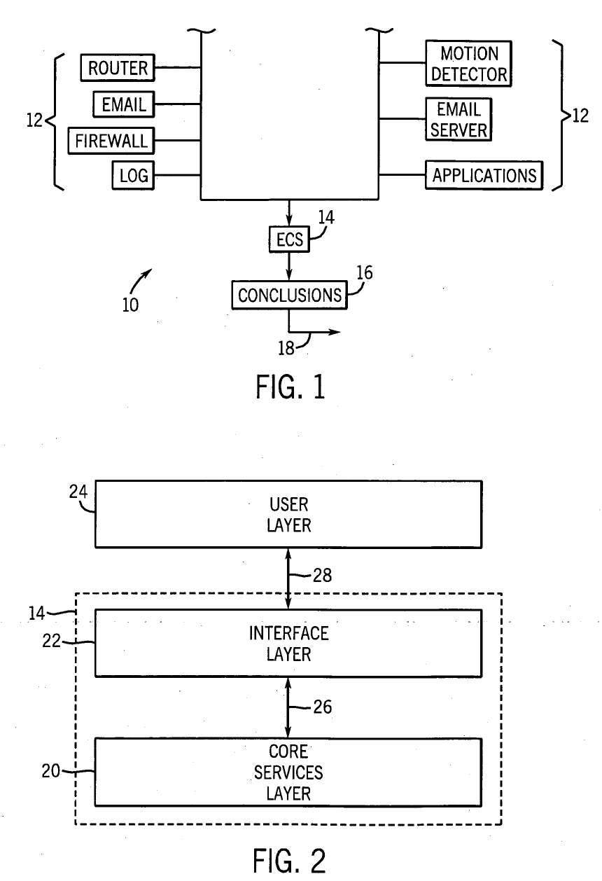

Referring first to FIG. 1, a possible embodiment of network 10 is shown in block diagram format. Network 10 could include a multitude of event generating pieces or systems. Additionally, network 10 may include one or more interconnected event generating units, such as a computer network, data network or communications network. In the present embodiment, network 10 includes a number of event generating units 12. Event generating units 12 include a router, email, firewall, system log, a motion detector, email server, and an application. Event generating units 12 may be interconnected in an intranet fashion, or they may also be connected to an external network such as the World-Wide-Web, commonly known as the Internet.

Event generating units 12 are connected to an event correlation system (ECS) 14. In the present embodiment, a single ECS 14 is shown. However, event correlation systems may also be interconnected or may form part of a larger network. ECS 14 is intended to perform three major functions. ECS 14 aggregates, correlates, and then reaches conclusions based on such correlation. Conclusions 16 could include, for example, an alarm that is generated when a certain number of routers on network 10 experience and report a certain event, such as a denial-of-service attack. Such conclusions are then forwarded to a destination or host of destinations through communication link 18. An alarm, for example, may be forwarded to an IT administrator and enable a certain action to be performed, such as closing a port or turning a device off. As such, ECS 14 functions to take events and draw certain conclusions from them. Depending on the complexity of network 10, these events could range from several hundred to over several hundred million in a particular time interval. ECS 14 allows this potentially overwhelming amount of information to be transformed into a manageable result.

Turning to FIG. 2, a block diagram of ECS 14 is shown in accordance with one embodiment. Event producing sources, event receiving destinations, a user, and their interaction with ECS 14 can be viewed as a three-tiered block diagram, as FIG. 2 depicts.

Referring to FIG. 2, core services layer 20 serves as a platform, above which interface layer 22 and user layer 24 operate. In one embodiment, the software that comprises core services layer 20 may be written in the Java language. Core services layer 20 may provide the base software architecture for ECS 14.

In one embodiment, core services layer 20 may provide a set of system independent services to interface layer 22 and user layer 24. Those services may include event queuing and routing, configuration management, authoring and package management, security and access control, archive management, communications, performance management and statistics, real-time and archive event stream searching and querying, report tabulation, licensing and usage reporting, initialization and process control, load balancing and cluster control, database services and directory services. In effect, those services are independent from, but may supplement the core function of ECS 14, which is to correlate events.

Connection 26 serves as a data, communications, and system link between core services layer 20 and interface layer 22. Connection 26 links core services layer 20 with interface layer 22. Interface layer 22 is intended to be a physical and symbolic interface between user layer 24 and core services layer 20.

Interface layer 22 is intended to separate the core architecture in core services layer 20 from the architecture that comprises interface layer 22 to allow for greater flexibility, scalability and configurability. Connection 28 serves as a data, communications, and system link between interface layer 22 and user layer 24. In one embodiment, connections 26 and 28 may include several distinguishable links, which may be physically or organizationally distinct.

User layer 24 in the present embodiment is a representation of the systems and processes associated with a user and their interaction with ECS 14. User layer 24 as represented includes event producing sources and event receiving destinations. Specifically, user layer 24 includes the representation of the event producing sources 12 in FIG. 1. Since these event producers can be a number of different forms, such as a router or simply an email-sending server, they will be collectively referred to and categorized as “event sources”. The organizational makeup of interface layer 22 and user layer 24 will be discussed in more detail below.

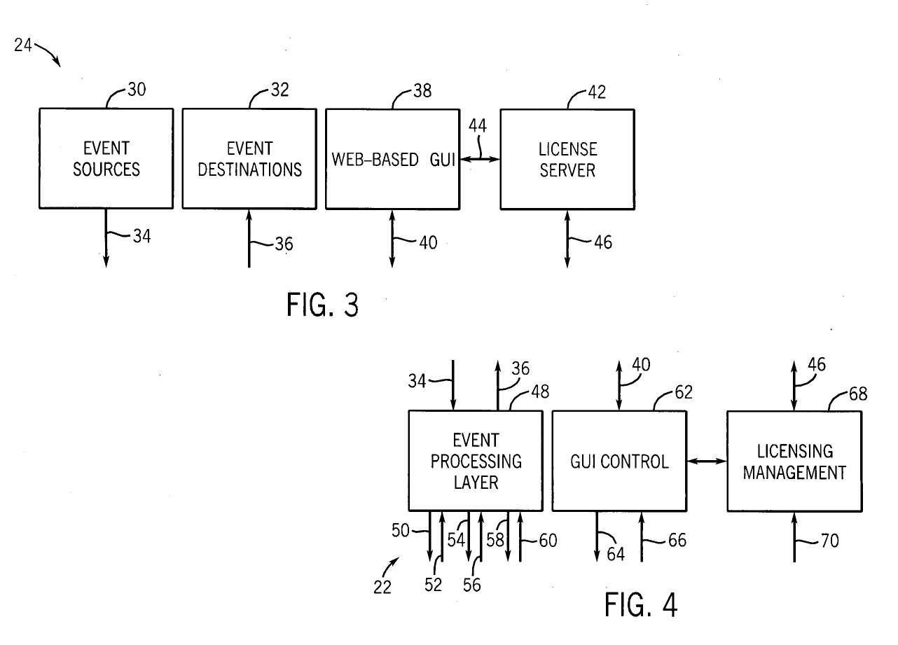

Referring to FIG. 3, a block diagram view of user layer 24 is shown. Again, user layer 24 represents in block form the aggregate and collective number of user operations as they relate to ECS 14.

Connection 28 from FIG. 2, depicting a data, communications, and system link between user layer 24 and interface layer 22 is presently described in additional detail as it relates to FIG. 3. Referring again to FIG. 3, four distinct links, of which connection 28 is comprised, are seen. Event sources component 30, which again is a representation of the plurality of event producing sources 12 as depicted in FIG. 1, is shown sending event sources stream 34 to interface layer 22. In addition, event destinations component 32, which again is a representation of the plurality of event receiving destinations, is shown receiving event destination stream 36 from interface layer 22.

Because events come from a variety of event producing sources, they may take the form of one of an available host of protocols. Protocols are simply the “language” of an event. Additionally, protocols may control the way that an event is transmitted. For example, emails are generally sent by an email server using simple mail transfer protocol, or SMTP. SMTP protocol includes sender information, information about the respective data being sent, and receiving information. Put another way, SMTP is a set of rules regarding the interaction between a program sending e-mail and a program receiving e-mail.

Event sources component 30 is representative of and includes applications that create events and event streams through a variety of protocols from a variety of sources, such as applications, servers, firewalls, authentication and authorization systems (such as biometric authorization systems), physical security systems, card key locks, motion detection systems, computer networks, wireless telephone and data networks, email servers and other sources. In one embodiment, event destinations component 32 includes existing system, network, security and physical management infrastructure, such as network and security management consoles, email, paging and notification systems, problem tracking systems and automated system administration scripts and programs.

Again, referring to FIG. 3, web-based graphical user interface (GUI) 38 is shown adjacent to event destinations component 32. In one embodiment, web-based GUI 38 acts as the physical operational and control interface between a user and ECS 14. In one embodiment, web-based GUI 38 sends Simple Object Access Protocol (SOAP) requests to interface layer 22 through data connection 40. Connection 40 also carries answered SOAP requests from the interface layer back to web-based GUI 38.

License server 42 is seen adjacent to web-based GUI 38. In one embodiment, web-based GUI 38 connects to license server 42 through data connection 44 to allow the user to perform self-administered license management, purchasing and provisioning. License server 42 is also connected to the interface layer through data connection 46.

Turning now to FIG. 4, a block diagram view of interface layer 22 is depicted. Event processing layer 48 is shown as a subset of interface layer 22. Also shown are connections 34 and 36 with data sources component 30 and event destinations component 32 in user layer 24, respectively.

Core services layer 20 provides a set of plug-ins for the modules of event processing layer 48. These plug-ins are provided through a set of application programming interfaces (APIs) and configuration controls. These APIs and configuration controls are central to the function of ECS 14 and will be discussed below in more detail. By way of introduction, application programming interfaces describe the process by which an application program (a complete program that performs a specific function directly for the user) can access the computer's operating system.

As a preliminary introduction, APIs 52, 56 and 60 are depicted as connected to event processing layer 48 and between event processing layer 48 and core services layer 20. In addition, configuration controls 50, 54 and 58 are depicted connected to event processing layer 48 and between event processing layer 48 and core services layer 20.

Referring again to FIG. 4, GUI control 62 is seen adjacent to event processing layer 48. In one embodiment, GUI control 62 receives SOAP requests from web-based GUI 38 through data connection 40. GUI control 62 then forwards the SOAP requests via data connection 64 to the core architecture in core services layer 20. In one embodiment, GUI control 62 is configurable to receive transmission control protocol/internet protocol (TCP/IP) data or information from core services layer 20 through data connection 66. GUI control 62 is highly decoupled and independent from the core architecture in core services layer 20 via standard protocols. Again, the removal of GUI control 62, in one embodiment, from the core architecture of core services layer 20 is intended to allow for maximum flexibility and configurability.

In one embodiment, GUI control 62 performs information and status management, configuration management, process and component control, event stream/archive subscriptions, searching and querying and reporting and tabulation.

Referring again to FIG. 4, licensing management module 68 is seen adjacent to GUI control 62. In one embodiment, licensing management module 68 is configured as a subject of interface layer 22 to remove it from core services layer 20, again with the intention to allow flexibility in license management functionality. Licensing management module 68 provides an interface for on-line error, bug and enhancement reporting. In one embodiment, licensing management module 68 makes requests to license server 42 in user layer 24 using data connection 46 to request license keys, license extensions, and to receive such data in return.

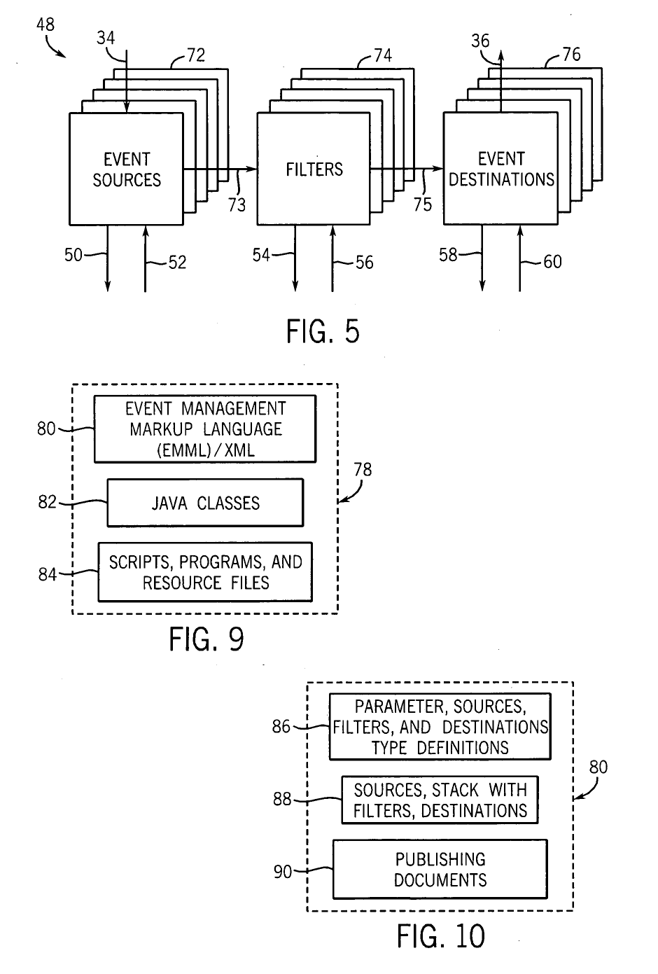

Referring now to FIG. 5, a block diagram view of event processing layer 48 is depicted. Three system object categories are seen comprising event processing layer 48, and will be discussed in greater detail below. The system objects in event processing layer 48 perform a plurality of duties, and comprise a large part of the function of ECS 14. In one embodiment, the depicted categories reflect an intent to translate, organize and manipulate incoming events, correlate those events and finally, send the correlated result to a specific destination outside of ECS 14.

As a preliminary matter, event sources stream 34 is again seen in FIG. 5, carrying a stream of events down from event sources component 30 located in user layer 24. Again, event destinations stream 36 is seen delivering processed event information to the outside world via event destinations category 32 also located in user layer 24.

In one embodiment, event sources category 72 converts events from a certain incoming protocol into an internal information schema that is processed through interface layer 22 and core services layer 20. Event sources category 72 is configurable and flexible to allow for the acceptance of a host of various protocols, including SNMP, Syslog, NT events, text logs, archive files, email/SMTP, databases, session logs, shell actions and XML TCP/IP protocols. The conversion from various input protocols to a single, internal information schema allows for additional modularity, flexibility, and configurability in various applications.

Event sources category 72 behaves as a “module” in ECS 14. Event sources category 72 serves in an ECS 14 to assist in performing functions related to the acquisition, organization, or routing of event streams into the system.

For example, event sources category 72 may serve to instruct the system to open a specified port on a specified port number. It then may instruct the system to receive the event from a specified host through the specified port. Once an event stream is routed into the system, event sources category serves to instruct the system to forward it to a respective filter, where it will be correlated. Event flow arrow 73 depicts this logical flow pattern, describing an event being forwarded to filters category 74 for correlation.

Event sources category 72 works in conjunction with core services layer 20 to accomplish its tasks. Event sources category is comprised of, in a real sense, specialized, configurable instructions that tell core services layer 20 how to perform specific tasks related to event sources. As a result, event sources category 72 works to facilitate tasks in the system relating to event sources.

Filters category 74 is comprised of cohesive units of functionality that are intended to perform well-defined tasks on event streams flowing through ECS 14. In one embodiment, filters 74 are chained together inside filter stacks to solve specific application problems. Filters 74 is comprised of a variety of filter types which include edit filters, which are intended to modify events, routing filters, which are intended to control event flow, correlation filters, which are intended to perform event correlation, action filters, which are intended to launch processes, database filters, which are intended to query a database, diagnostic filters, which are intended to provide development support and scripting filters, which are intended to provide a scripting interface for filter development.

Filters category 74 also acts as a module in the system. Its basic function is to enable and facilitate the correlation of specified event streams. Again, filters category 74, like event sources category 72, are made up of specialized, configurable instructions that tell core services layer 20 how to perform specific tasks related to event correlation. Filters category 74, like event sources category 72, acts as a facilitator in this regard.

As a next step in the flow of an event stream, correlated event streams, as processed through filters category 74, are forwarded to event destinations category 76. Event flow arrow 75 depicts this logical flow pattern, describing an event being forwarded to destinations category 76 where it will be processed further.

Event destinations category 76 is comprised of a variety of protocols and interfaces through which events and notifications can be forwarded to the outside world. Like event sources category 72 and filters category 74, event destinations category 76 behaves like a module. Again, specialized, configurable instructions make up this category, as they relate to event destinations. Event destinations category, then, instructs, enables, and facilitates the ECS 14 to take correlated, processed event streams and forward them to specified destinations outside the system and to the outside world.

Event destinations category 76 may instruct the system to send a processed event stream to a specified destination. For example, a series of TextLog event streams that have been correlated and processed through event filters category 74 may then be forwarded to an archive destination, where event destinations category 76 may instruct that they be written to a file.

The respective application programming interfaces (APIs) and configuration controls located in event processing layer 48 will presently be discussed in more detail. Configuration controls 50, 54 and 58 are seen connecting event sources category 72, filters category 74 and event destinations category 76 with core services layer 20.

In one embodiment, the architecture of ECS 14 uses object-oriented programming to define and identify four separate and distinct “types”. Specifically, the architecture defines parameter, source, filter, and destination as types. Again, this is a reflection of the intent to organize incoming event streams by source, aggregate, detect and correlate events using filters or filter stacks, and once processed, send a result or conclusion to a destination, all using predefined parameters.

In light of the above, configuration controls 50, 54 and 58 serve to register these predefined types into core services layer 20. Configuration controls 50, 54 and 58 tell ECS 14 when an interface module, specifically event sources category 72, filters category 74 or event destinations category 76 is available.

ECS 14, in one embodiment, makes extensive use of extensible markup language, or XML. Extensible markup language provides a flexible way to create standard information formats and share both the format and the data on a platform such as the World-Wide-Web. XML is a widely-used language standard that facilitates the interchange of data between computer applications. The widespread use of XML in ECS 14 allows the creation of “tags” which are customizable for a particular use or application. These tags enable the definition, transmission, validation, and interpretation of data between applications running on ECS 14.

An example of the function of configuration controls 50, 54 and 58 follows. Specifically, the following sample XML and example illustrates the function of configuration control 54 as it applies to filters category 74:

<filterType

description=“If event matches %Condition%,
for each unique value of

%FieldName%, perform %ActionList% if count reaches
%Threshold% within
%TimeInterval%.”

objectId=“CountUniqueEventsFilter”
schema=“”>
<implement
class=“com.eventgnosis.filters.CountUniqueEventsFilter”
source=“ecs.jar”
type=“Java” />

</filterType>

In light of the above, configuration control 52 notifies core services layer 20 and GUI control 62 that a 37 filterType” with the name “CountUniqueEventsFilter” exists, it is implemented in ECS 14 with “CountUniqueEventsFilter” class in the “Java” language, and that the class is located in the “ecs.jar” library file. Additionally, type “filterType” has the following parameters for configuration: %Condition%, %FieldName%, %ActionList%, %Threshold%, and %TimeInterval%. As such, this particular filter using a predefined filter tag is configured in the system.

Once configuration has occurred, application programming interfaces 52, 56 and 60 then work to instantiate a particular system object, call a method function or functions as they relate to that object, and, in some cases, shut connections down. In one embodiment, API 56, as it relates to filters category 74, performs the following example sequence. Again, sample XML code is shown for reference:

<filter objectId=“CountUniqueEvents”
type=“CountUniqueEventsFilter”>

<parameter comments=“Add comments for
Condition...” description=“Set

description for Condition...” type=“Condition”>

<negatePrimaryCondition>false</negatePrimaryCondition>
<conditionRelation>All</conditionRelation>
</parameter>
<parameter type=“FieldName”>enter field name</parameter>
<parameter comments=“Add comments for
ActionList...” description=“Set

description for ActionList...” type=“ActionList” />

<parameter type=“TimeInterval”>

<time>99</time>

<units>yr</units>

</parameter>

</filter>

In light of the above, API 56 works to create a new object instance of filter type “CountUniqueEventsFilter” which is Java class “CountUniqueEventsFilter”. “CountUniqueEventsFilter” is given its instance name of “CountUniqueEvents” by the user, and finally, it has the above parameter definitions.

In one embodiment, API 56 may perform the following sequence of events. First, a Java object is instantiated, such as “CounterUniqueEventsFilter”. Next, a method call is made, such as calling public void setVars(Log log, String name, SystemObject myMgr, ConfigurationManager configMgr, EmmlConfig ecfg), which, in this case, initializes the filter object. Finally, a call is made to public ArrayList processEvent (Event ev) repeatedly for each event which the filter instance is to process. This function returns a routing list which comprises events and their specific destinations for forwarding.

API 52 and API 60 work in much the same way. In one embodiment, API 52, as it relates to event sources category 72, may perform the following sequence of events. First, a system object is instantiated. Next, setVars( ) is called once to initialize the filter object. Next, Connect ( ) is called once, which causes the source to connect to its data stream (e.g., open a connection), which is preparatory to receiving data. If necessary, Connect ( ) may be called repeatedly until a connection is established at increasing time intervals. Next, getNextEvent( ) is called repeatedly for each new event which the system is ready to process. This function performs whatever reading/receiving is necessary given the protocol, and returns a single event to the system for further routing and processing. Finally, Disconnect( ) is called which shuts down all connections gracefully.

In one embodiment, API 60, as it relates to event destinations category 76 may perform the following sequence of events. Again, a system object is first instantiated. Next, setVars( ) is again called to initialize either the system object or the destination object. Connect( ) is again called once, or repeatedly to cause the destination to connect to wherever it is sending the data to. Next, processEvent ( ) is called which sends/writes the particular event to outside protocols/mediums. Finally, Disconnect( ) is called to shut the connection down.

An important part of the functionality of ECS 14 is the integration of a plurality of system objects that include predefined and editable configuration parameters into the system, particularly their integration in event processing layer 48. These system objects and application components are organized in the same fashion as the core architecture of ECS 14, that being an event sources, filters, and event destinations user paradigm. A central feature of ECS 14 is its open and extensible architecture, which allows seamless integration of system objects with editable parameters.

Incoming event streams are converted by ECS 14 into an internal XML representation or XML schema. One of the main reasons for this conversion is to provide translation across various event protocols into a single system protocol that can be more easily manipulated. This protocol translation process will be discussed in greater detail below.

Finally, ECS 14 may be comprised of software that is embodied in a CD or other computer program product. This software may be publishable. In another embodiment, this software may be downloadable from a remote computer.

In one embodiment, ECS 14 converts all incoming text to an internal XML format. As such, it is important that any text that happens to already be in XML format not be confused with the internal XML representation. To prevent any confusion, input/output streams undergo the following substitutions as they enter ECS 14 through a source, which is referred to below as the “XML Character Translation Table”:

| External | | Internal ECS |
|---|---|---|
| Character | Character Name | Representation |
| < | Less than sign | &lt; |
| > | Greater than sign | &gt; |
| & | Ampersand | &amp; |
| ' | Apostrophe | &apos; |
| “ | Quote mark | &quot; |
| \| | Pipe symbol * | &ardlm; |
| \n | End of line * | &areol; |
| \r | Carriage return * | &arcr; |
| Anything else | Any other character | Not changed, left “as is” |

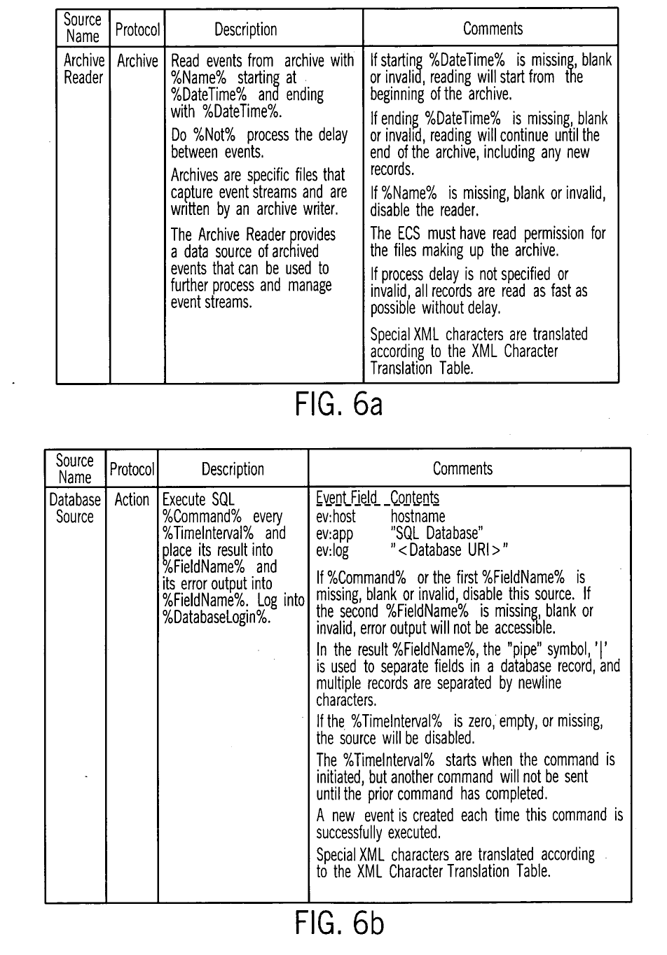

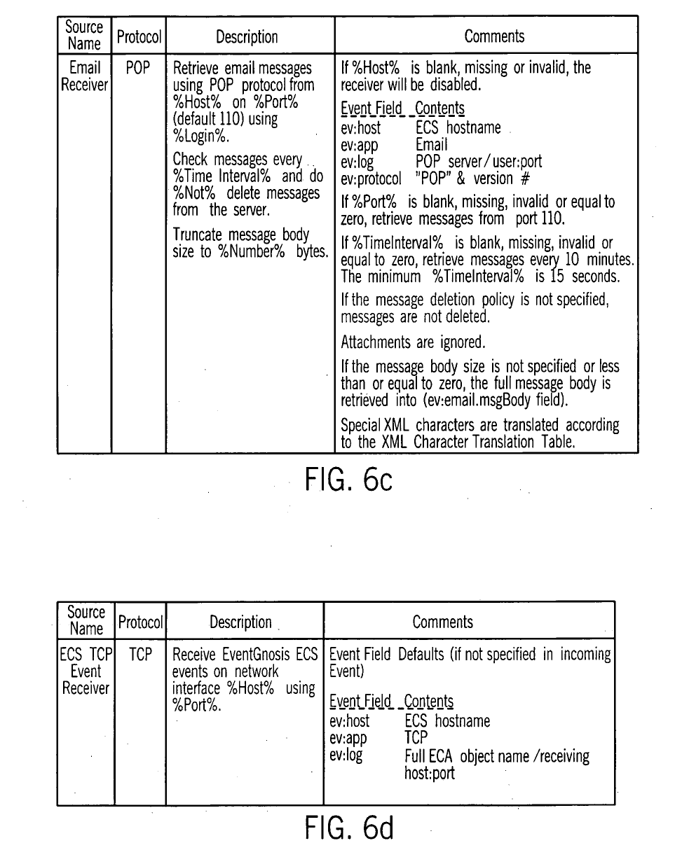

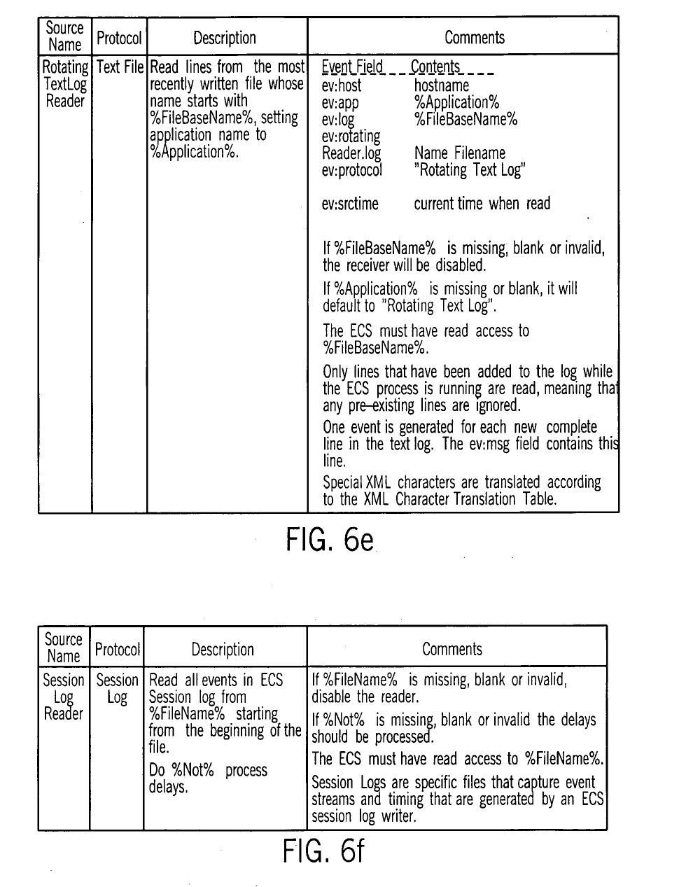

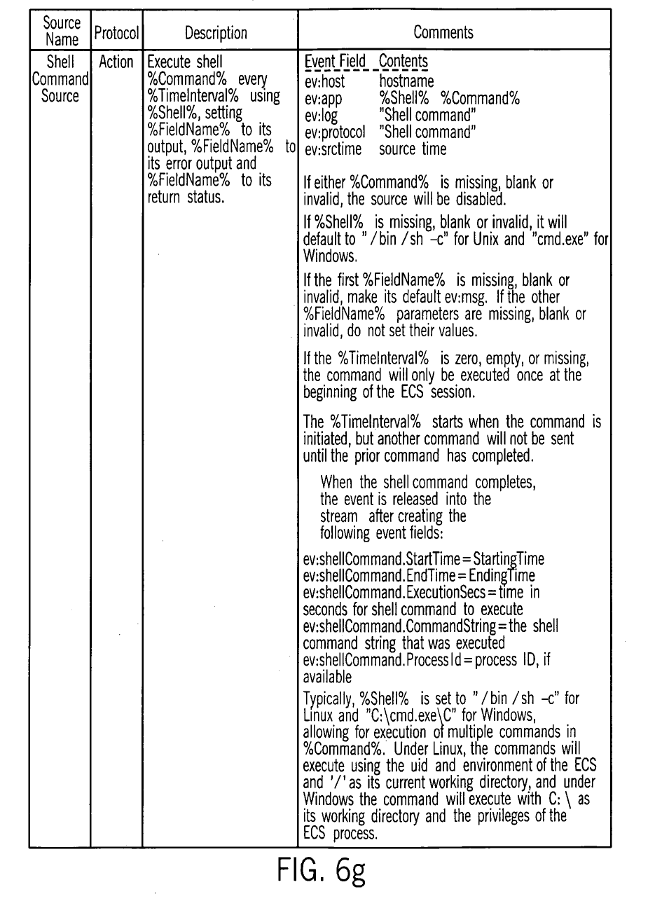

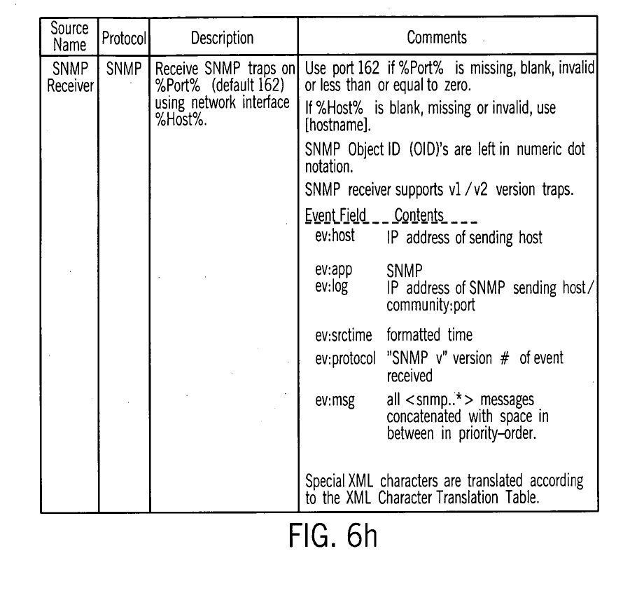

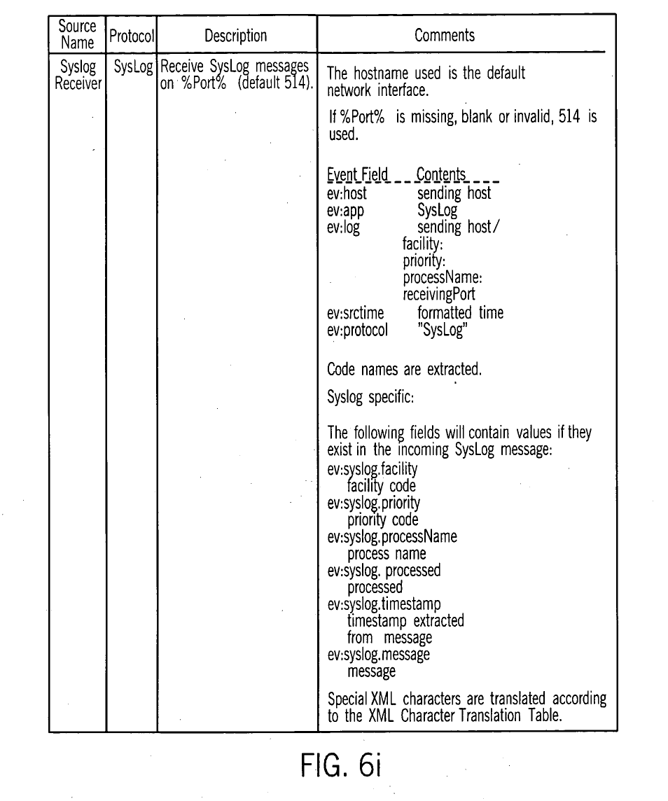

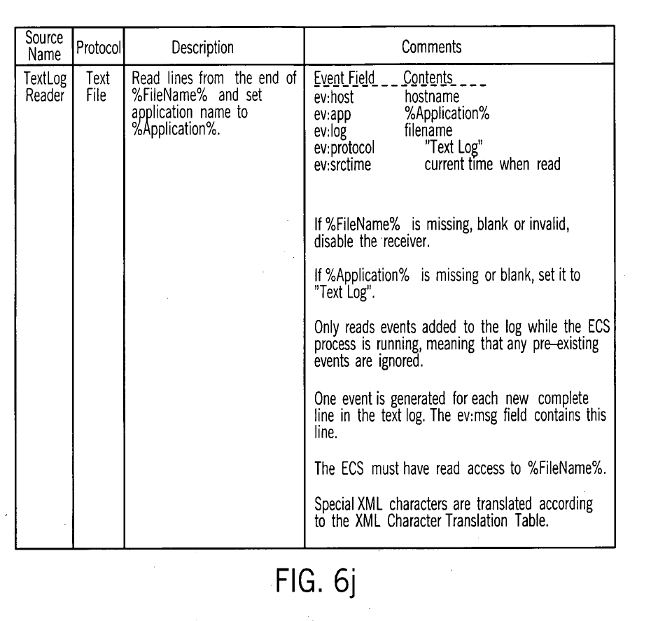

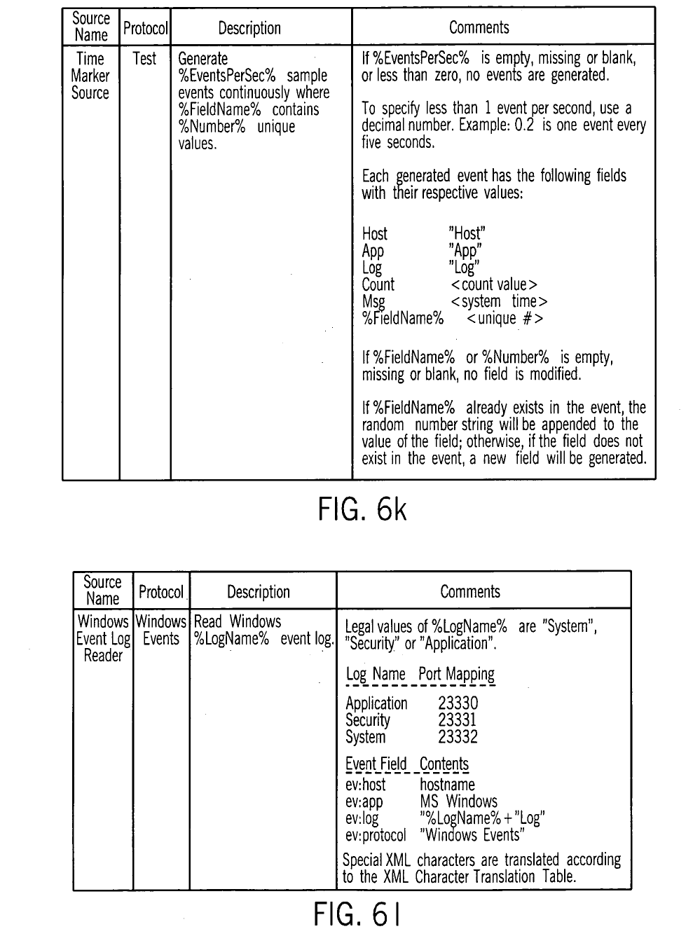

The system objects of ECS 14 will be presently illustrated and described in greater detail. Referring to FIGS. 6a-6l, the first category of system objects are event sources. FIGS. 6a-6l illustrate event sources category system objects by source name, protocol, description, and comments. Words which appear between % marks, such as %Name% or %DateTime% are configurable parameters of the system object.

For example, the “Archive Reader” named system object, which is in “Archive” protocol, performs the following natural language description of its function, as it appears in the description: “Read events from archive with %Name% starting at %DateTime% and ending with %DateTime%.” Events, are then read from an archive with the specified %Name% parameter, starting at a specified %DateTime% parameter, and ending with a specified %DateTime% parameter.

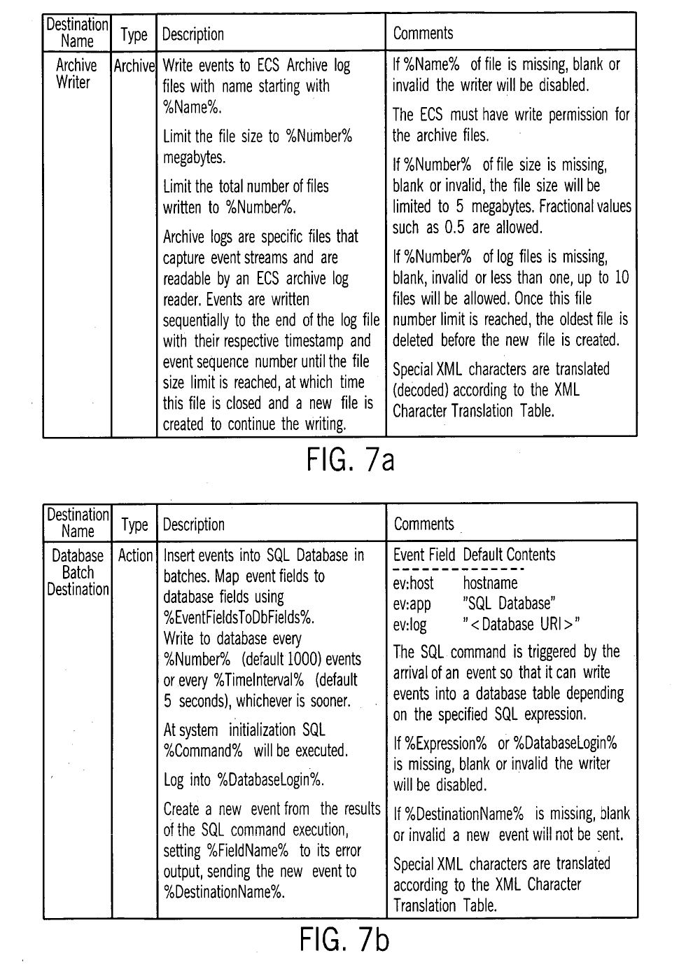

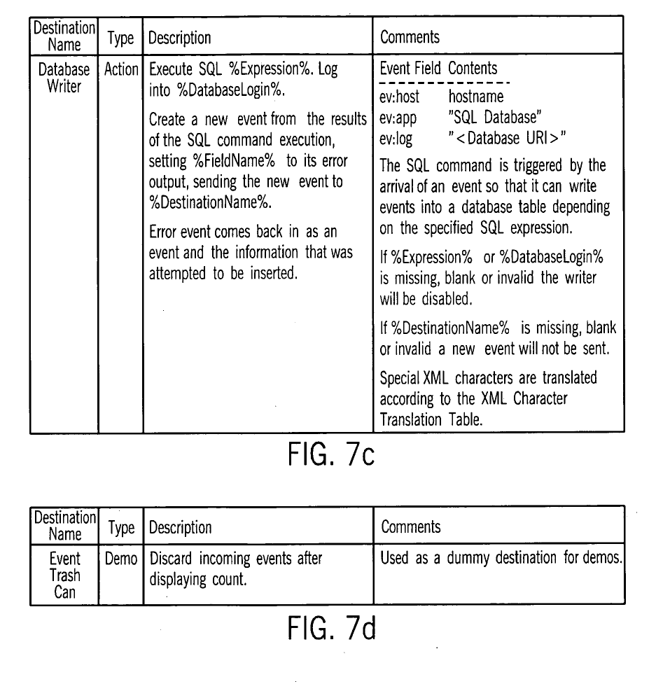

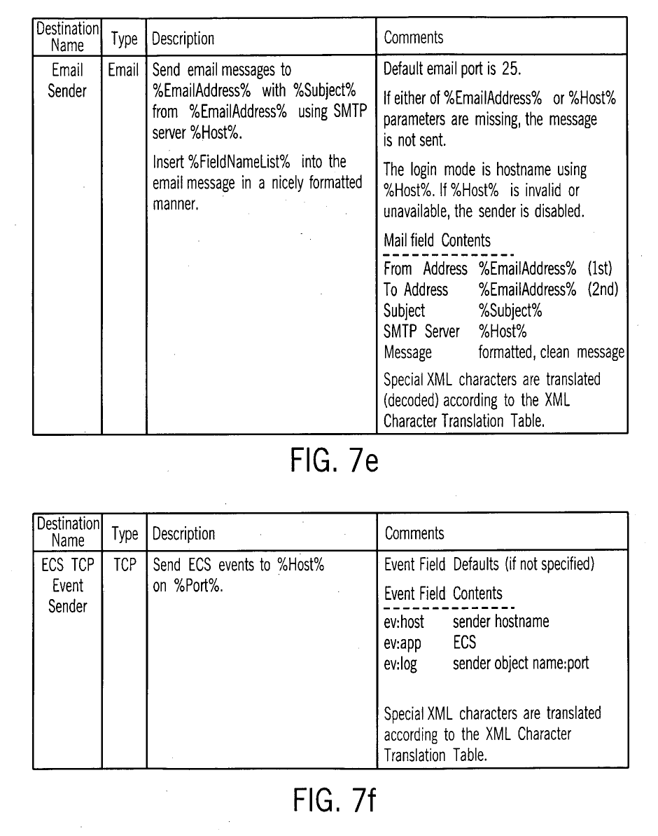

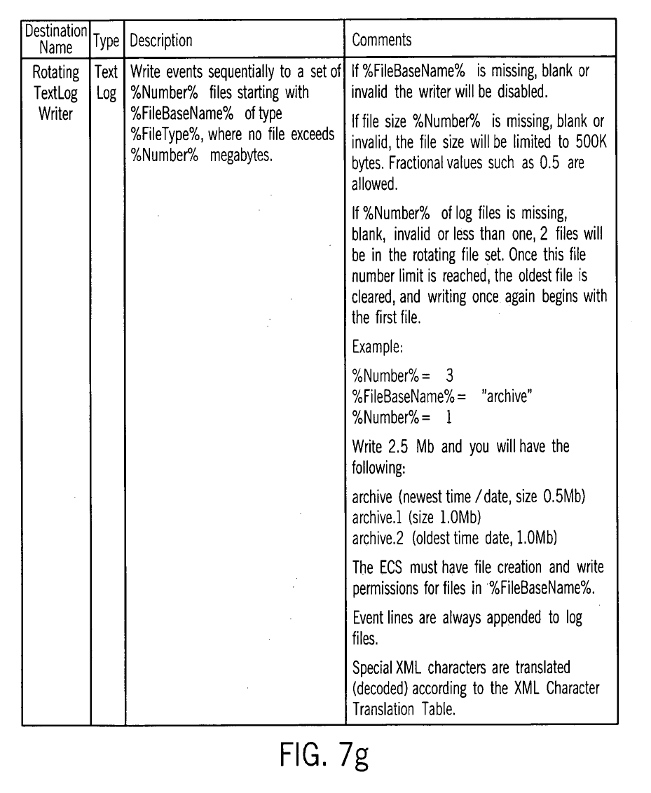

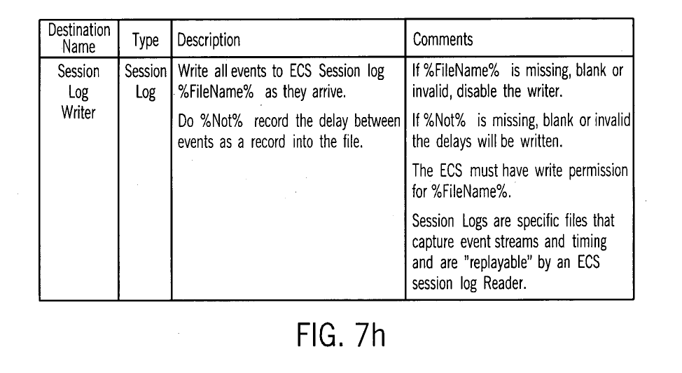

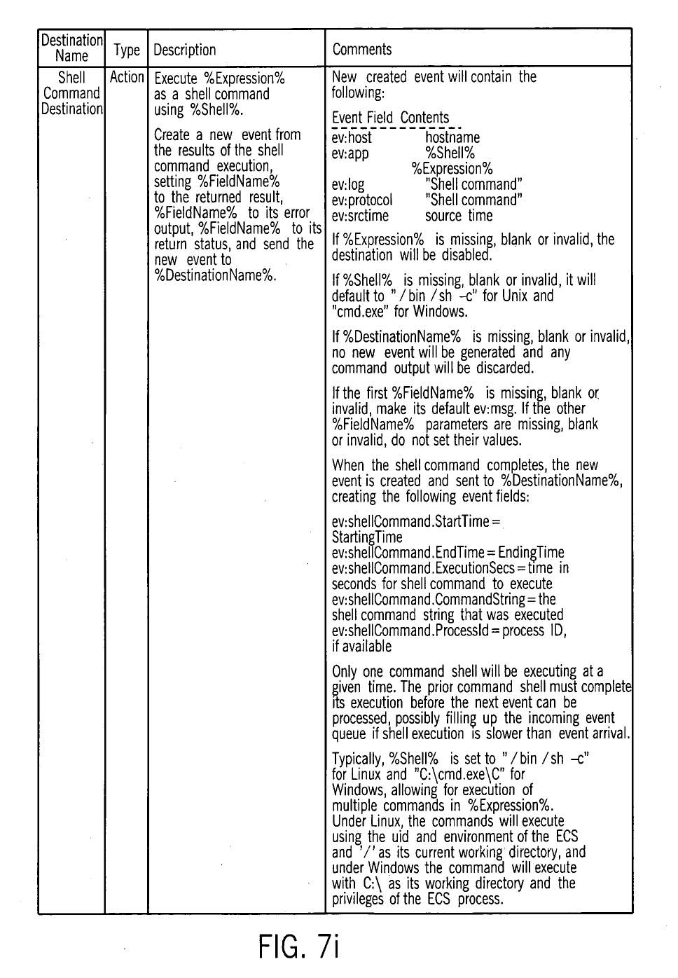

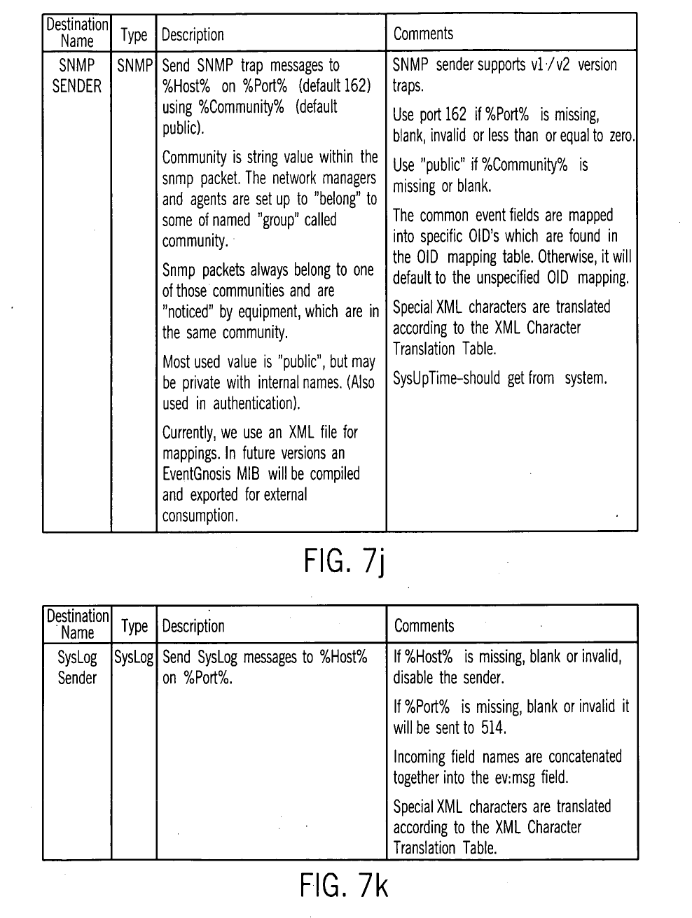

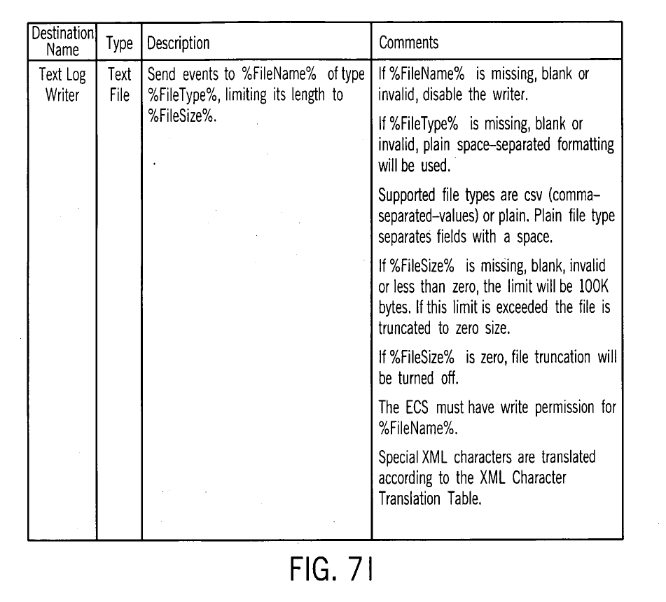

Referring to FIGS. 7a-7l, the second category of system objects are event destinations. FIGS. 7a-7l illustrate event destinations category system objects by destination name, type, description, and comments. Again, the previously described natural language description is depicted, which performs a specific task with configurable parameters in the system.

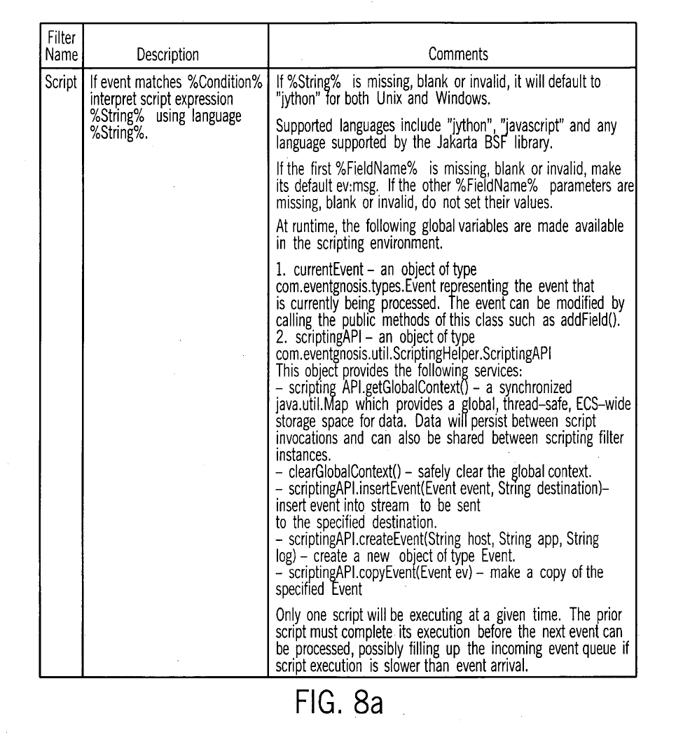

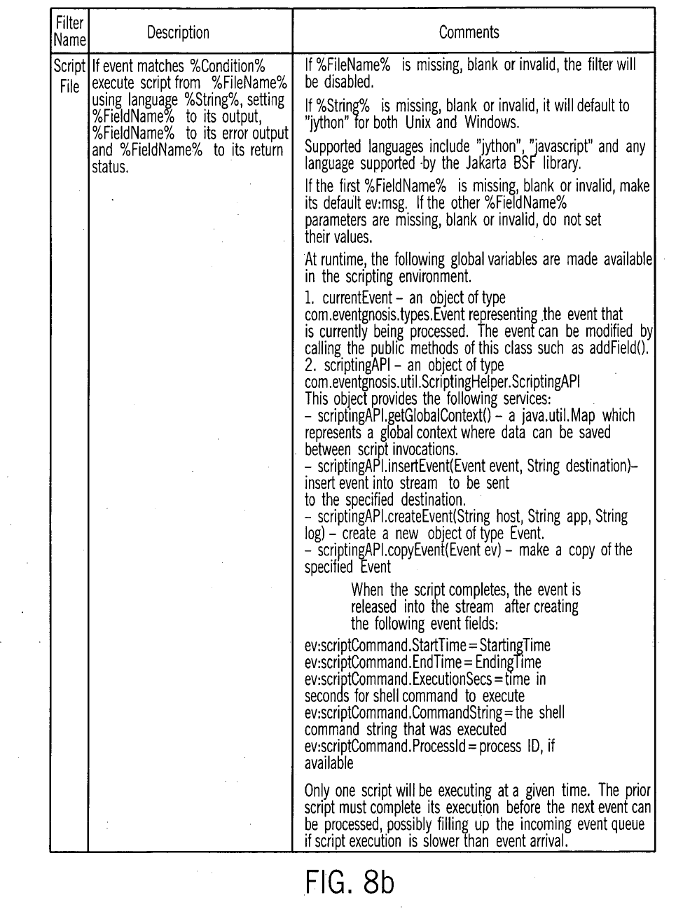

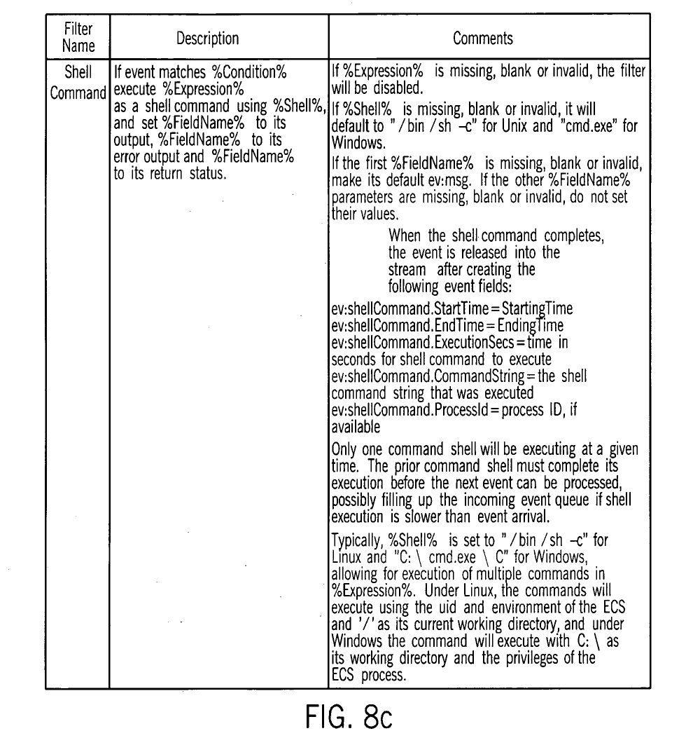

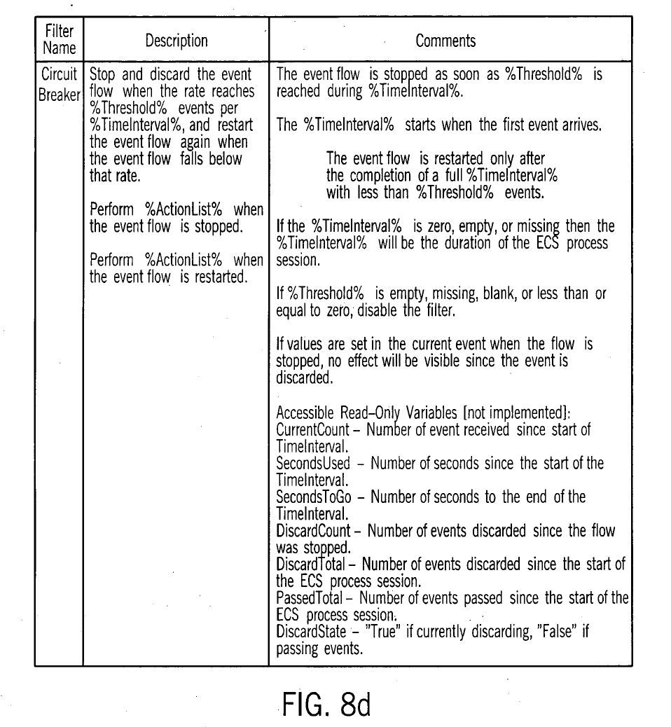

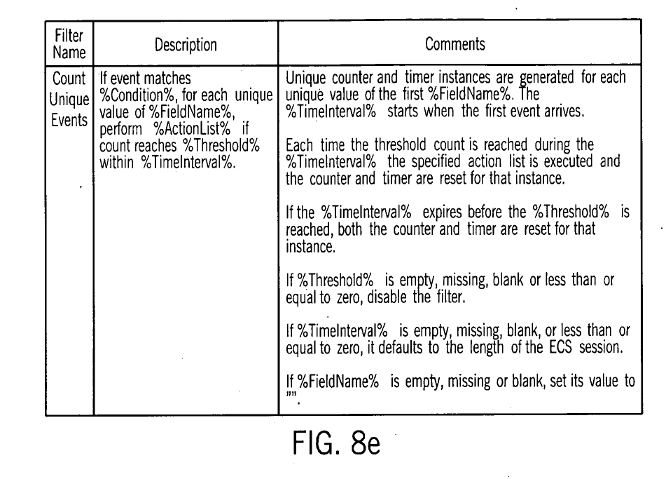

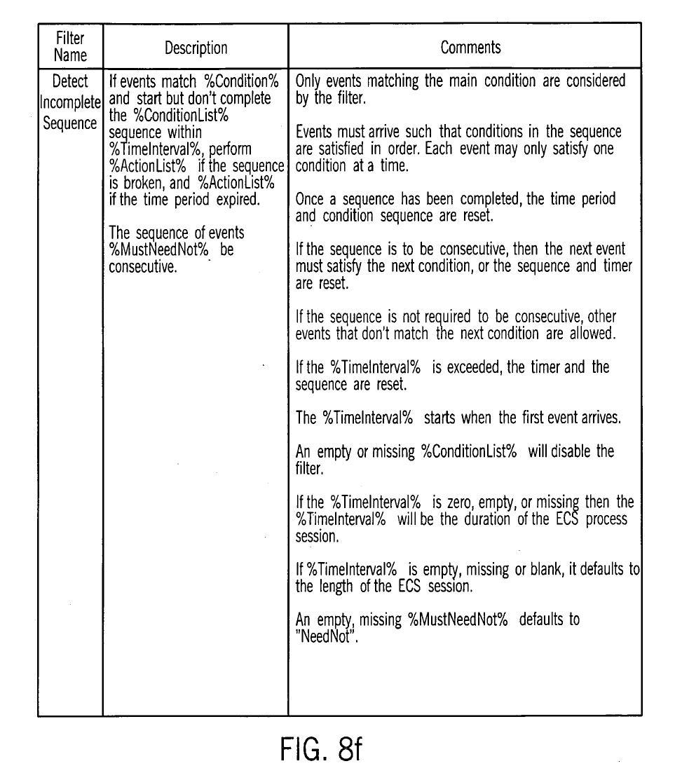

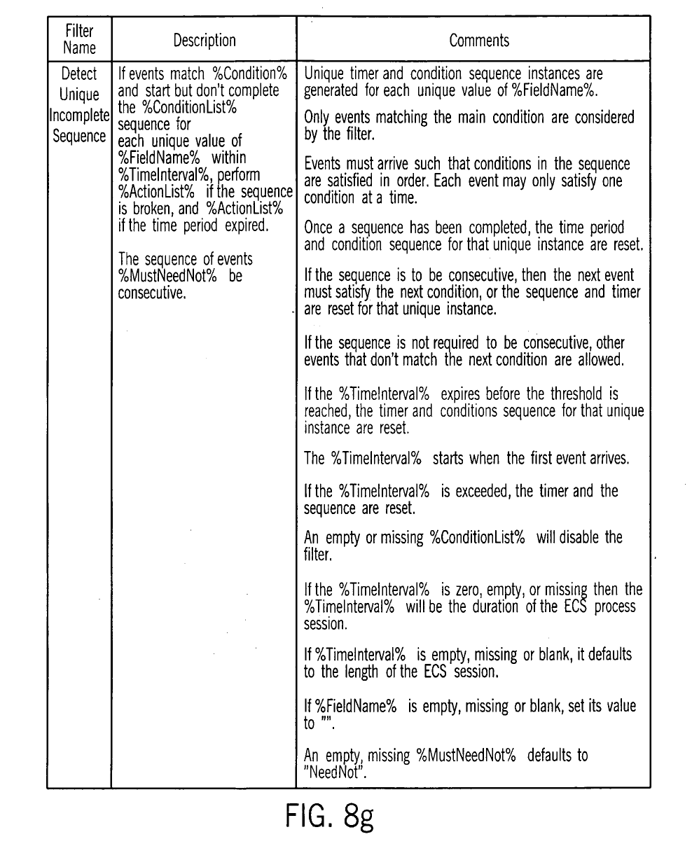

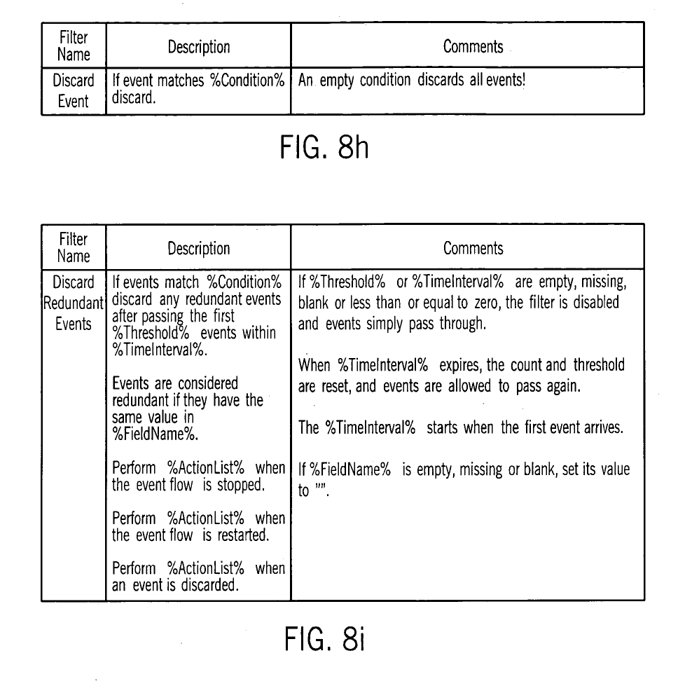

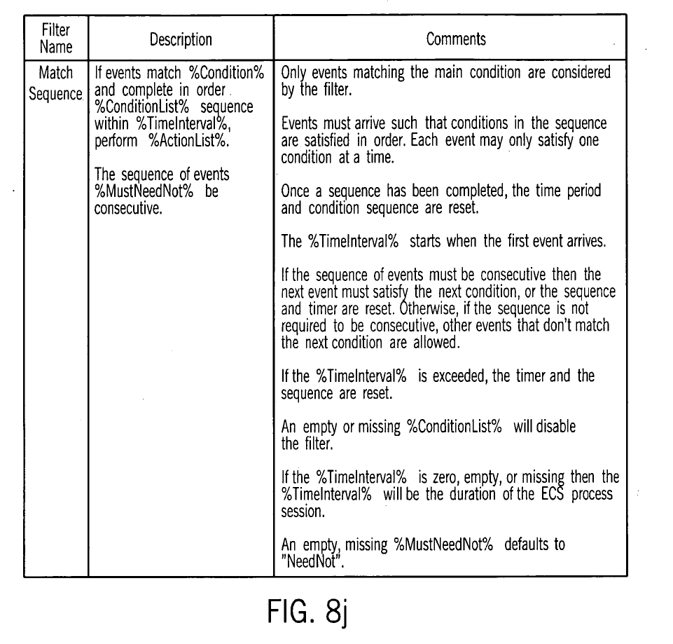

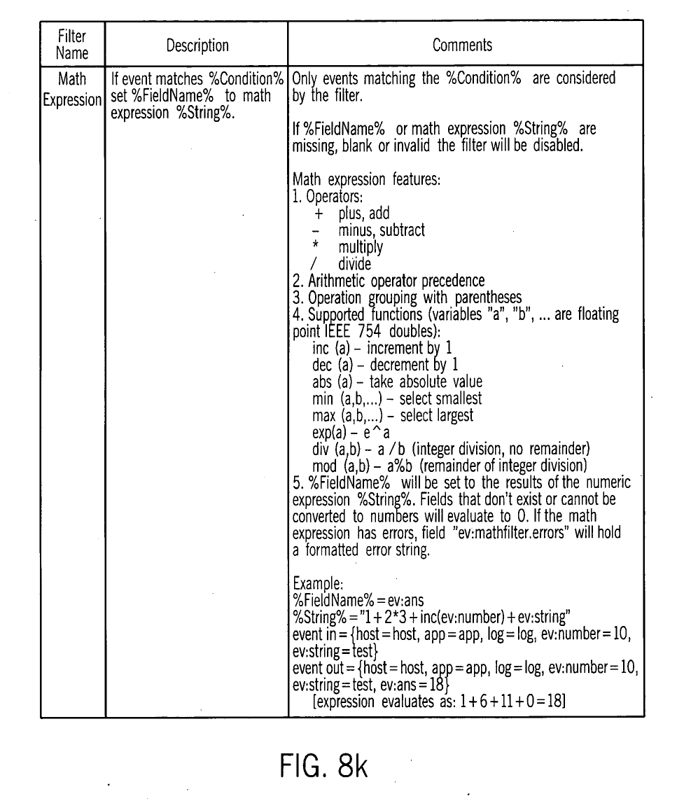

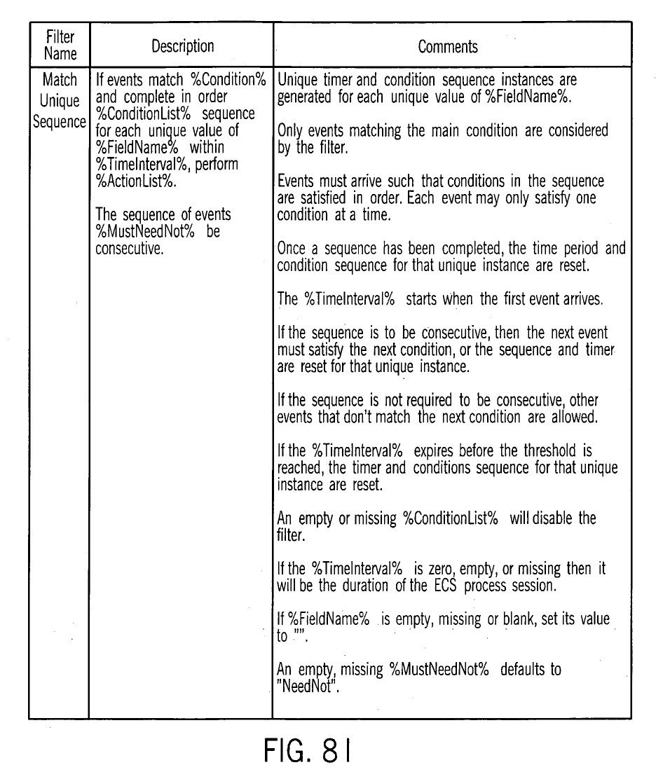

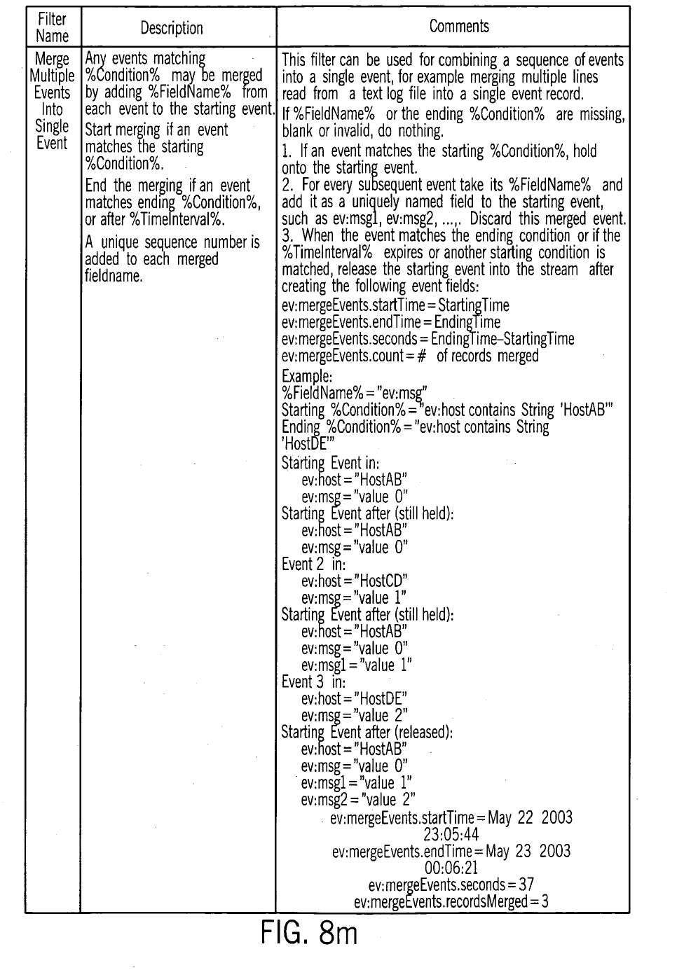

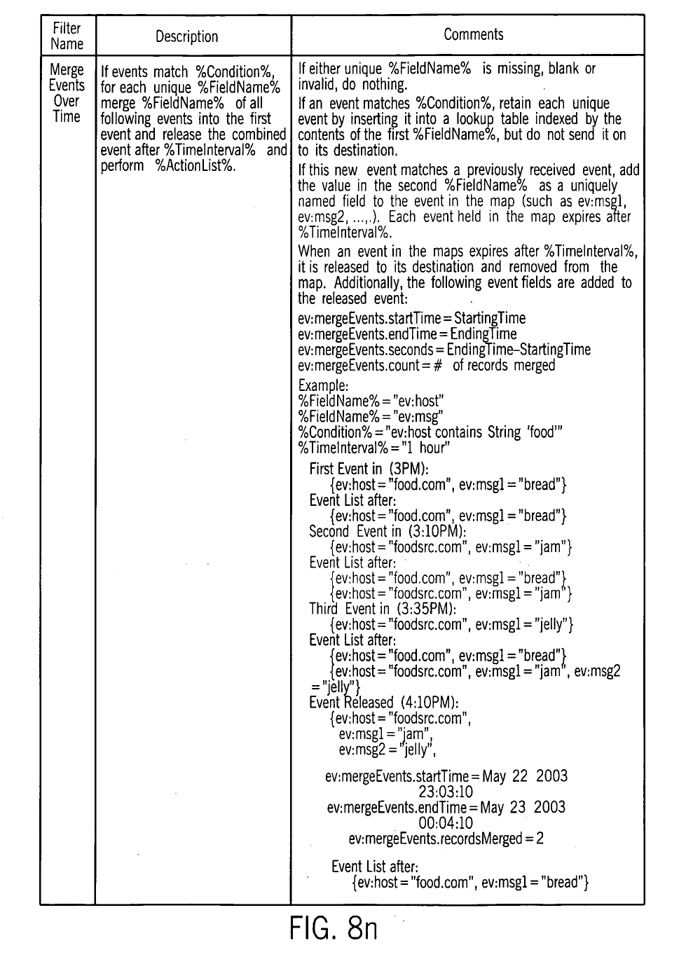

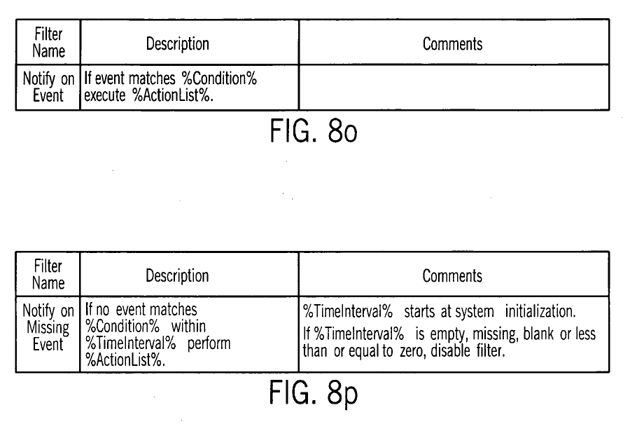

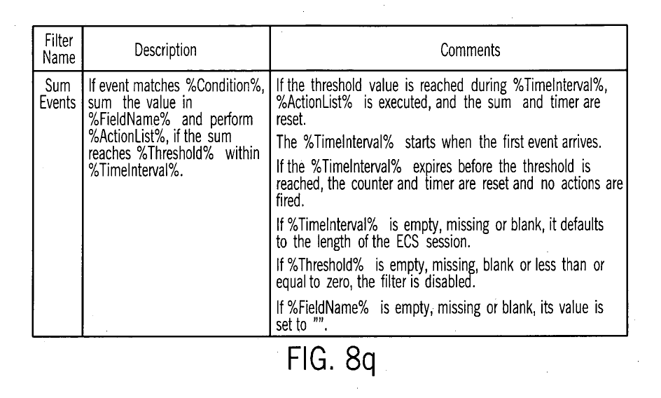

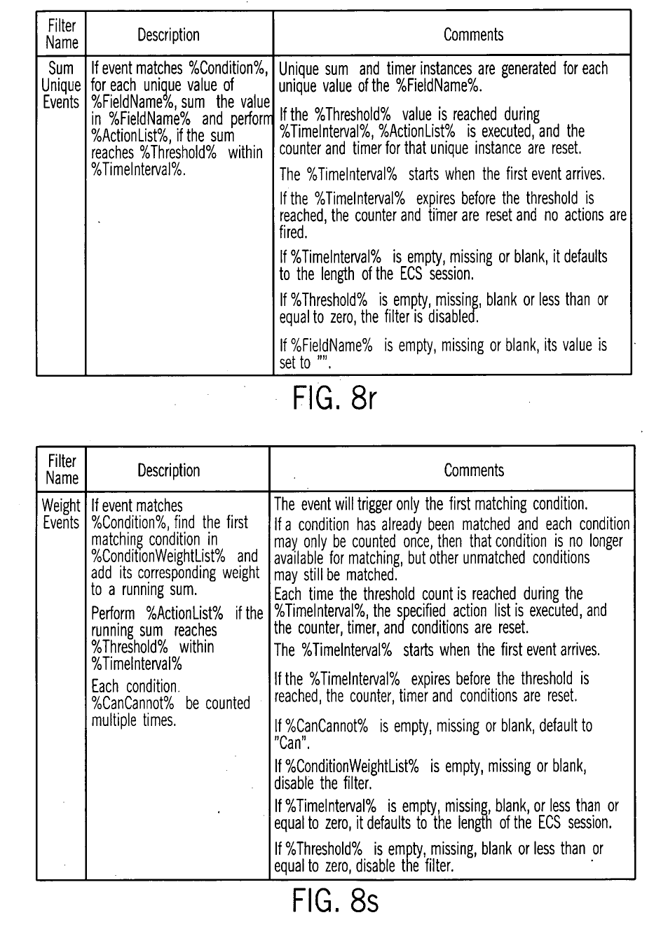

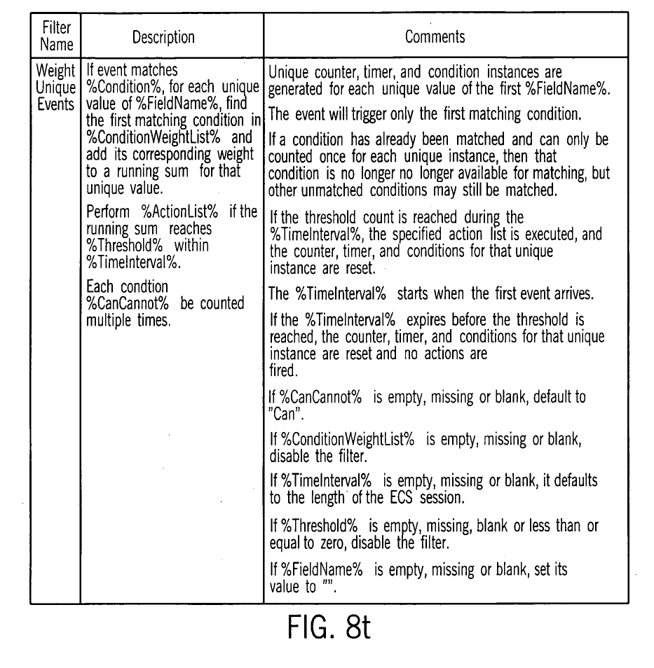

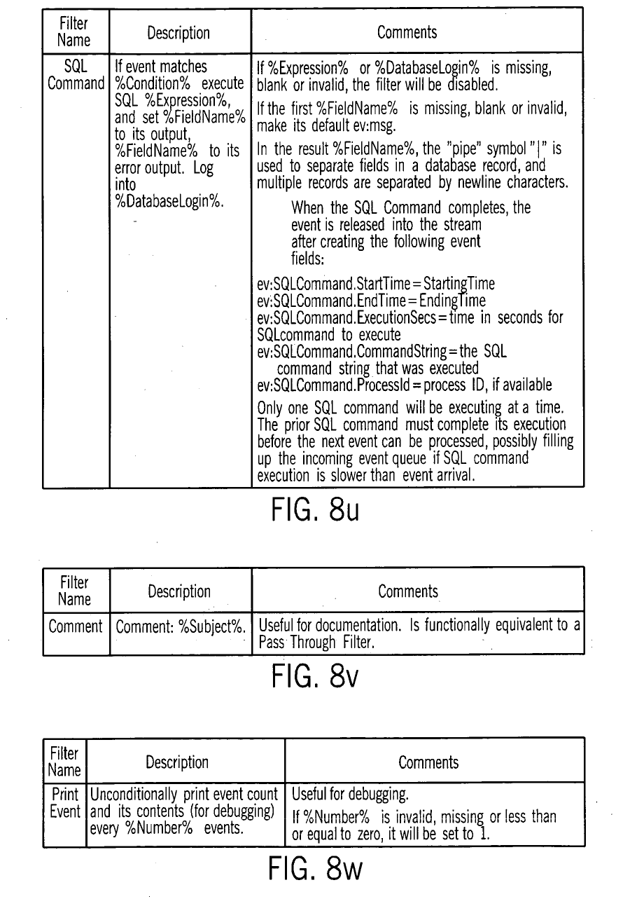

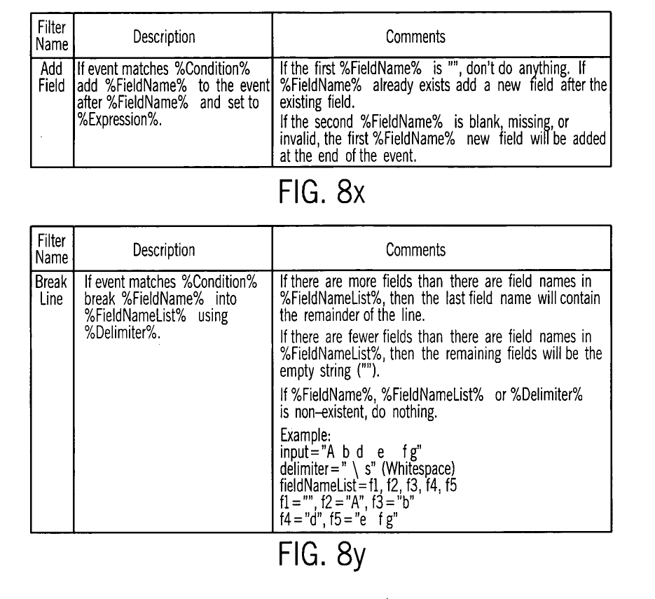

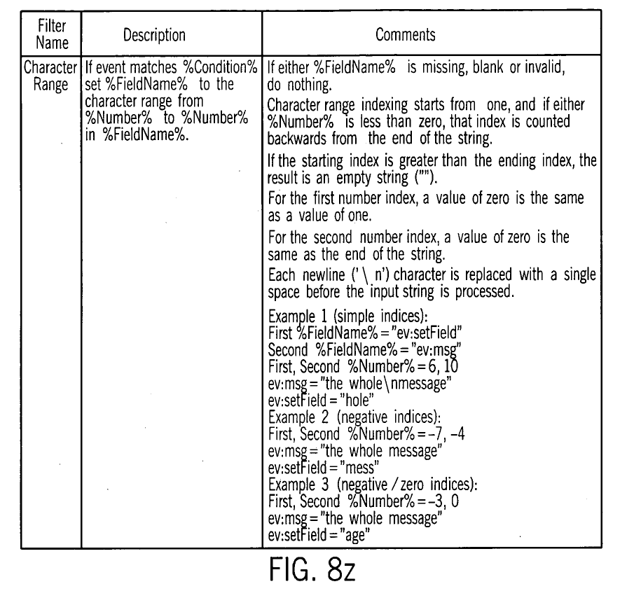

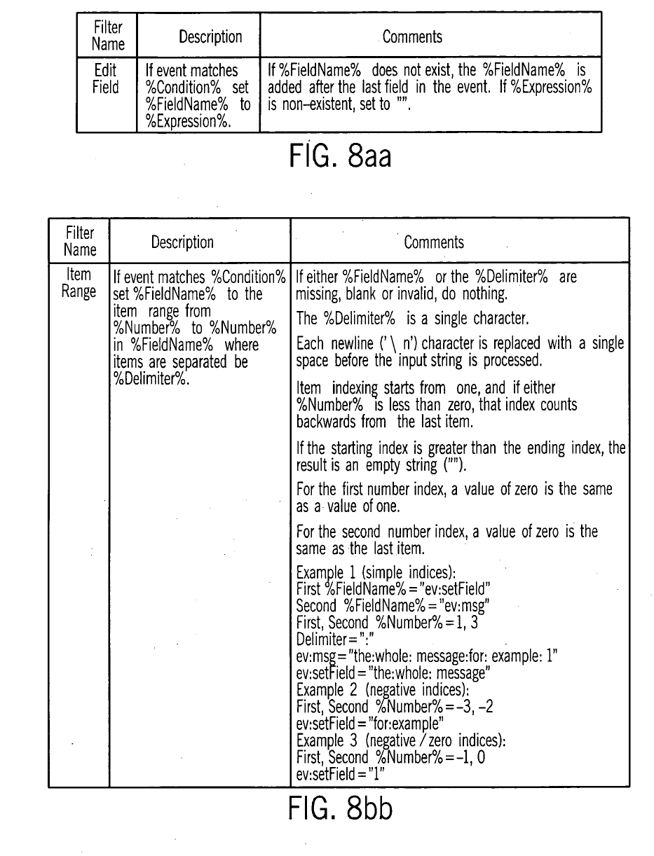

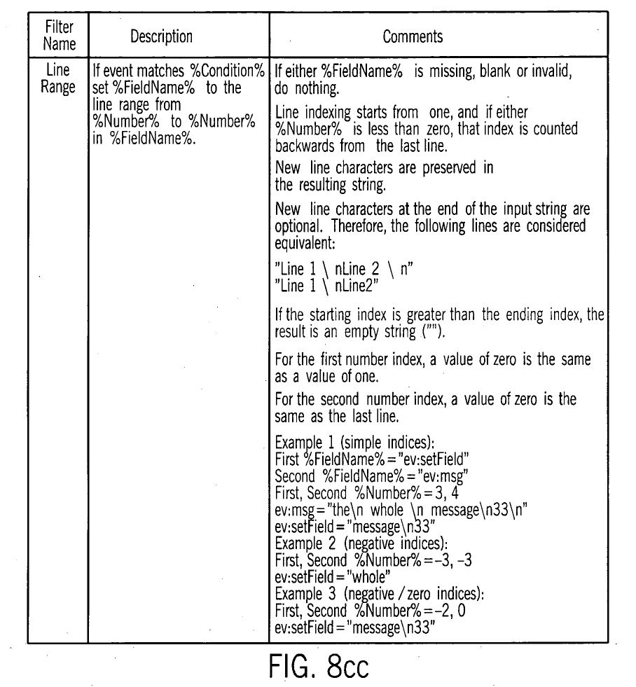

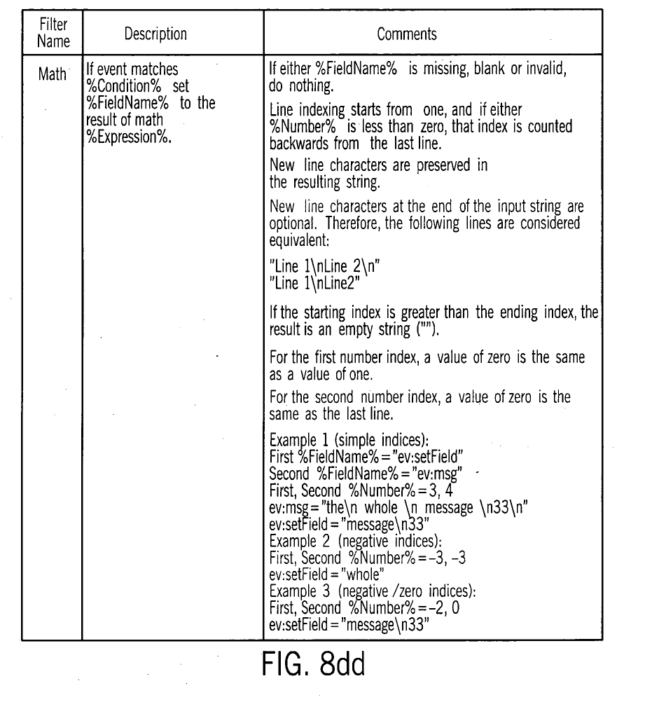

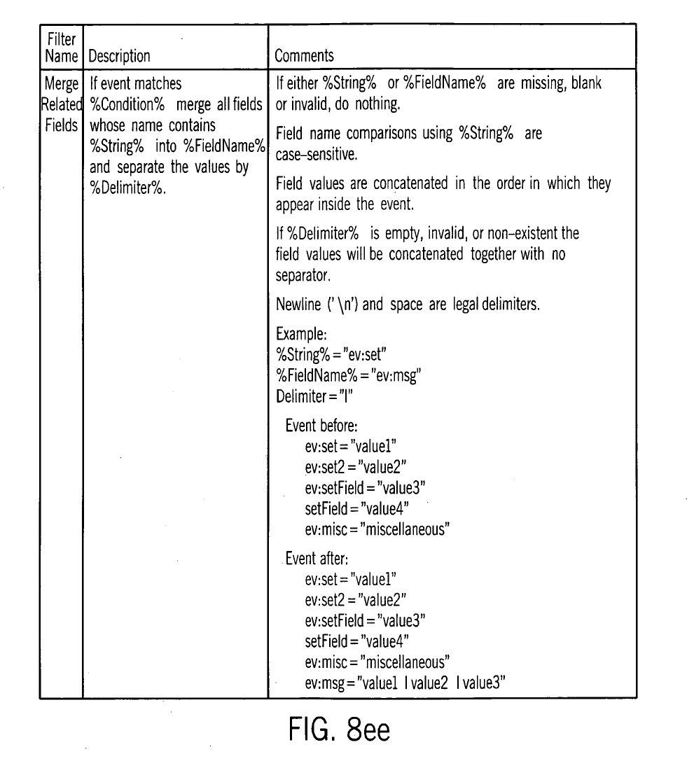

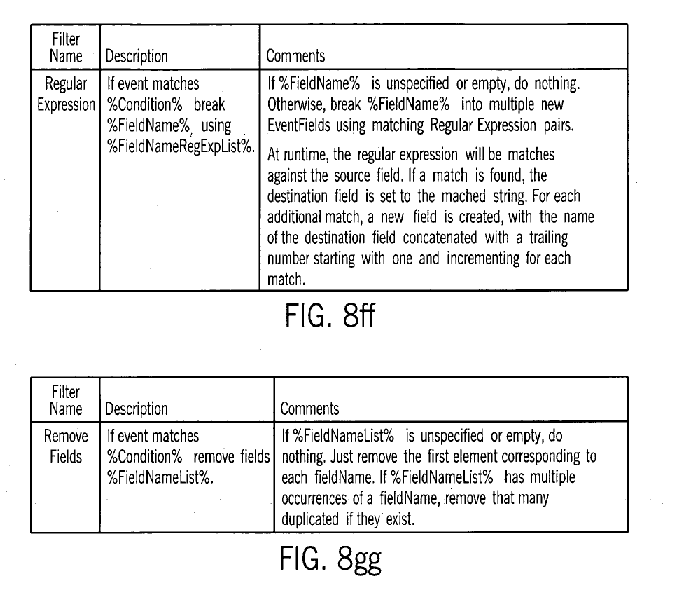

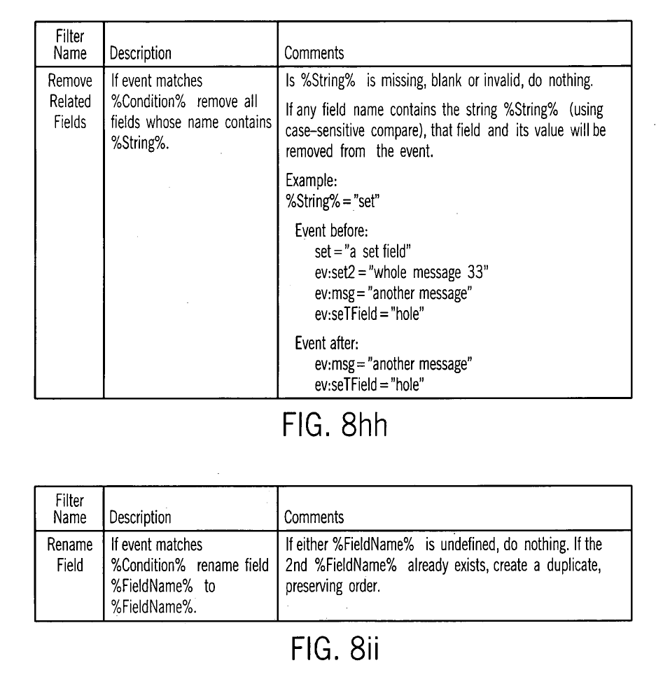

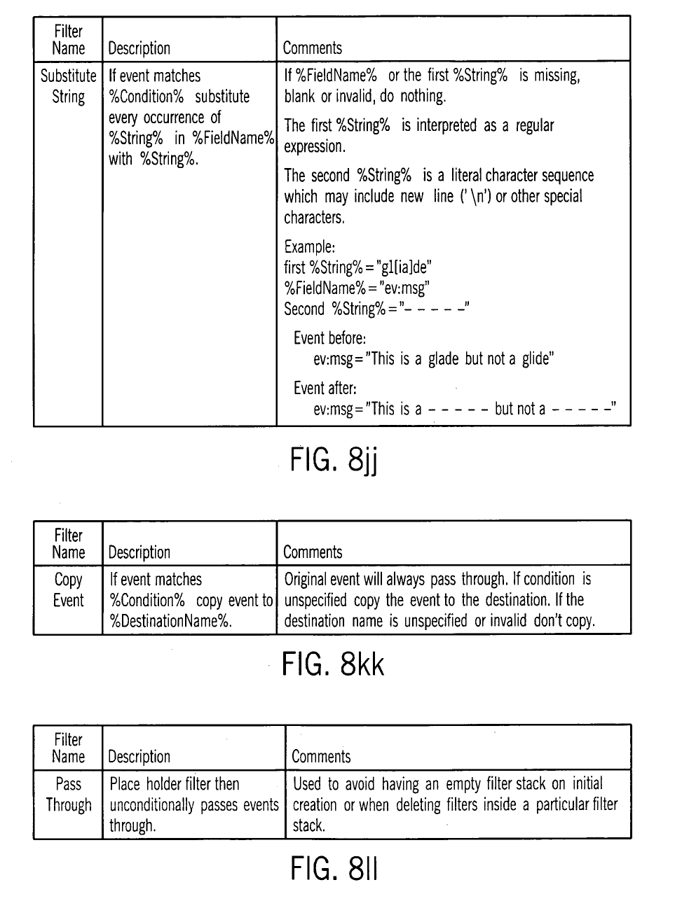

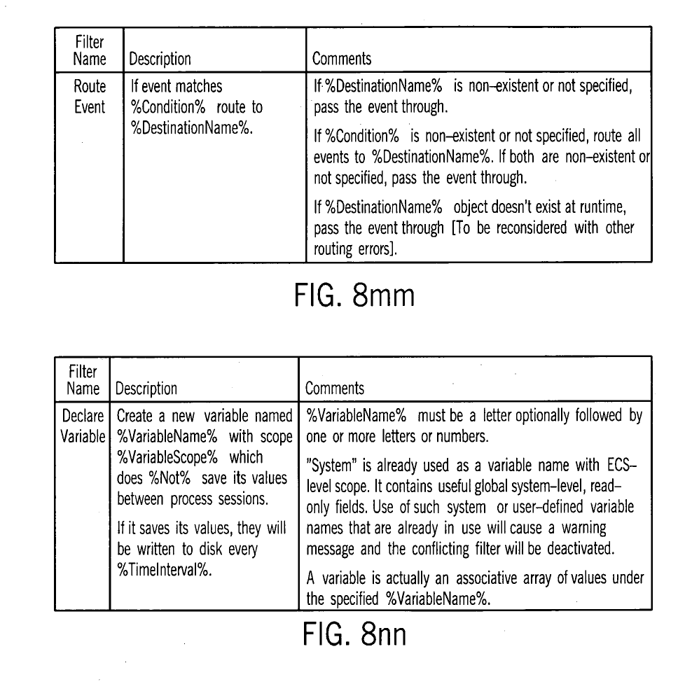

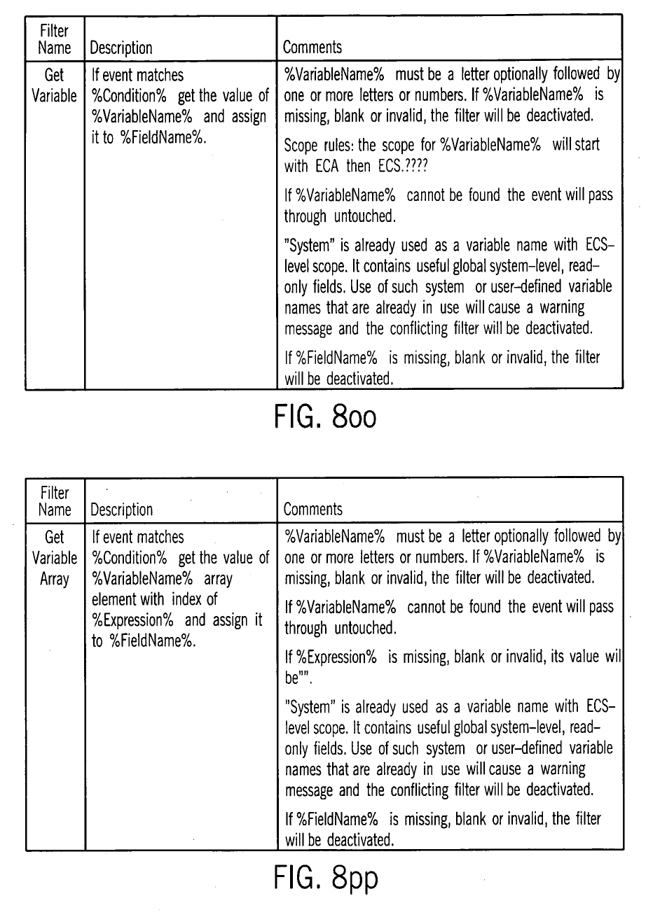

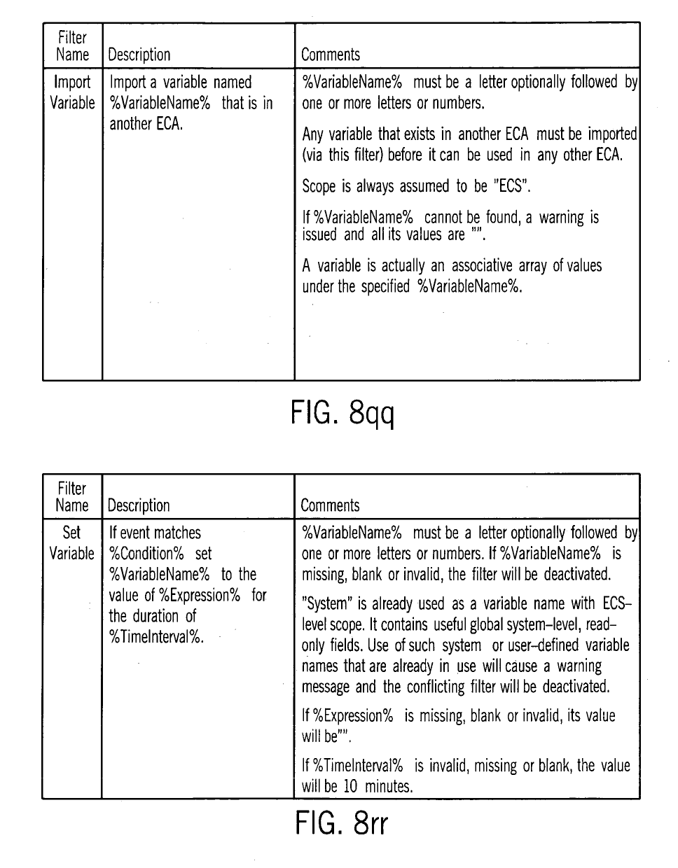

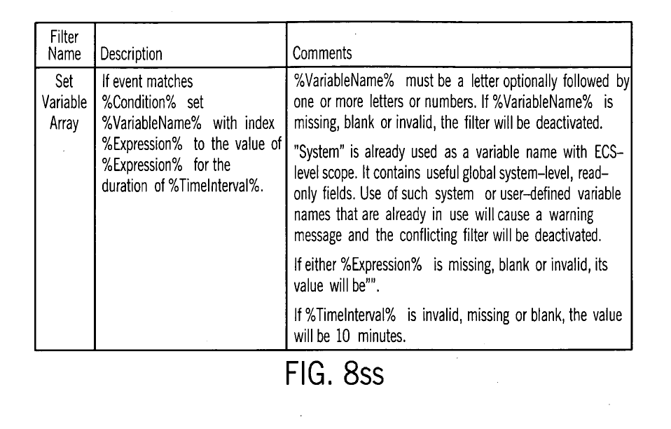

Referring to FIGS. 8a-8ss, the third category of system objects are filters. FIGS. 8a-8ss illustrate filters category system objects by filter name, description and comments. Again, a natural language description of the function of the respective system object is depicted, with configurable parameters.

Referring now to FIG. 9, an “Event Correlation Application” (ECA) is depicted in one embodiment. ECA 78 in its loosest sense is a file or a collection of information that is specific to a particular user. In one embodiment, ECA 78 is intended to integrate into interface layer 22. ECS 14 may include a plurality of event correlation applications 78 that comprise interface layer 22. As a simple analogy, interface layer 22 in ECS 14 behaves like a file cabinet, comprising many individual ECAs 78 or files that are specific to the individual user of ECS 14. ECA 78, then, is an association of information which is then interpreted by ECS 14.

Like ECS 14, ECS 78 can be embodied in a CD or other computer program product. It may be publishable. In another embodiment, it may be downloaded from a remote computer location, such as a file transfer protocol (FTP) server.

In FIG. 9, event correlation application 78 is shown comprising “Event Management Markup Language” (EMML)/XML 80, an internal XML representation or XML schema that is utilized by ECA 78. In one embodiment, the system objects depicted in FIGS. 6, 7 and 8 are comprised of EMML-written code. Additionally, Java classes 82 and scripts, programs and resource files 84 are seen comprising ECA 78. Java classes 82 are templates which encapsulate data and behavior, again represented in the Java language. Finally, scripts, programs and resource files 84 are additional data and information to allow each ECA to be individually configurable and functional.

Referring now to FIG. 10, a block diagram of EMML/XML category 80 in ECA 78 is depicted. EMML/XML category 80 is a key feature of the separate functionality of ECA 78. EMML 80 is written and organized the same configuration objectives in mind as ECS 14, which allows it to integrate seamlessly into the system architecture of ECS 14. As shown, EMML 80 is comprised of parameter, sources, filters and destinations type definitions 86, sources, stack with filters, destinations 88 and publishing documents 90. In one embodiment, EMML 80 is intended to allow individual configurability by a user using its internal XML schema and yet allow integration into interface layer 22 in ECS 14. The extensibility, modularity and flexibility of ECA 78 by using EMML 80 allows each ECA 78 to be individually tailored by a user to a specific implementation. In one embodiment, ECA 78 is intended to allow built-in objects to be updated independently of an update to ECS 14.

In one embodiment, ECA 78 registers types of sources, filters and destinations for use in an ECS 14 by (1) assigning a name, (2) associating a natural language description of its function, (3) defining the configurable parameters, and (4) utilizing an object library or class that implements the particular function.

Publishing documents 90, in one embodiment, is intended to provide for association of documentation and other user level information with ECA 78.

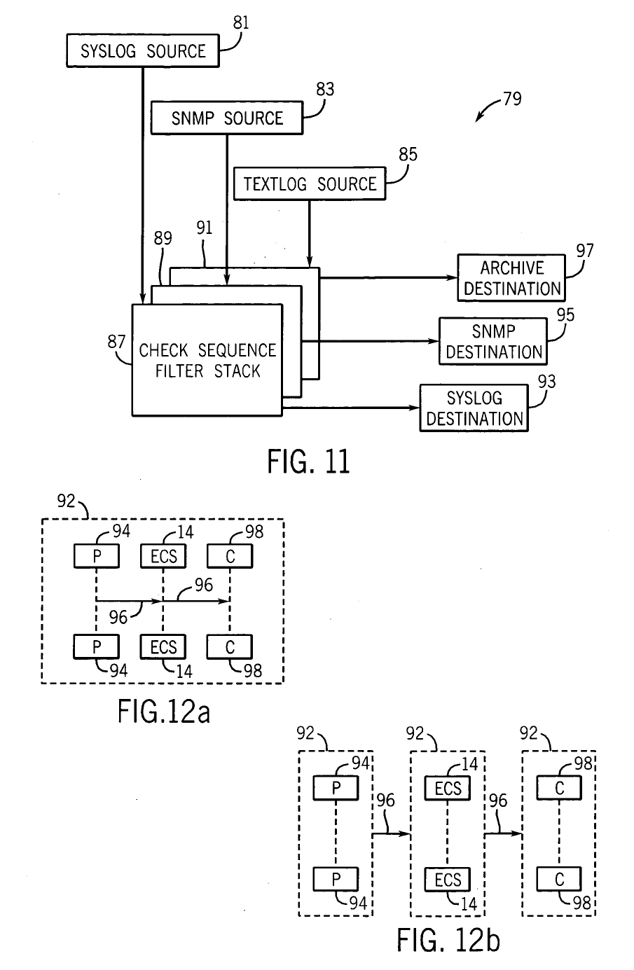

Referring to FIG. 11, a possible embodiment of ECA 78 is shown performing a functional example, depicted below as ECA example 79. ECA example 79 depicts three distinct sources that exist in their native respective protocols. SysLog source 81 is an event source represented in SysLog protocol. SNMP source 83 is an event source represented in SNMP protocol. Finally, TextLog source 85 is an event source represented in TextLog protocol.

SysLog source 81 receives SysLog messages on a specified port number. Specifically, the SysLogReceiver system object is utilized to perform this function. Additionally, a specified Java class is implemented to perform this function. Correspondingly, SNMP source 83 receives SNMP traps on a specified port number using a specified network interface. Specifically, the SNMPReceiver system object is used to perform this function. Again, a specified Java class is implemented to perform this function. Finally, TextLog source 85 reads lines from the end of a specified file name, and sets the respective application name to a pre-specified application. Specifically, the TextLogReceiver system object is used to perform this function. Again, a specified Java class is implemented to perform this function.

The sources depicted in ECA example 79 are representative sources. Any combination, associated parameters and configurations, connections and locations may be implemented. Again, the functionality of an ECA 78 allows the implementation of predefined source types, such as the ones depicted, or it may allow for the implementation of entirely new source types that are defined by a user. Additionally, predefined source types, their associated parameters and connections, may be individually or collectively configurable by a user. The parameters in this example such as ports, file names, application names, Java classes, etc., are all configurable and programmable by a user.

Referring again to FIG. 11, syslog source 81, SNMP source 83 and textlog source 85 are depicted routing event streams to-what is depicted as the “Check Sequence Filter Stack.” The depicted filter stack is comprised of three individual filters. These filters include the following: match sequence filter 87 receives an event stream from syslog source 81; correspondingly, copy events filter 89 receives an event stream from SNMP source 83; and copy events filter 91 receives an event stream from textlog source 85.

It is important to note that the sources depicted in ECA example 79 accept a plurality of event streams from a plurality of available protocols. These events are converted from their respective protocol into an internal XML representation or XML schema, which facilitates this protocol translation into a common format that is universal to the ECA and the ECS. Such multi-protocol translation and correlation is central to the functionality of an ECA, and the ECS as a whole.

The depicted “Check Sequence Filter Stack” is programmed and configured to examine the content of each incoming event. As a next step, the stack generates a new event if a sequence of predefined and configurable conditions has been satisfied. Specifically, match sequence filter 87 implements the following natural language description of its function: “If events match %Condition% and complete in order %ConditionList% sequence within %TimeInterval%, perform %ActionList%. The sequence of events %MustNeedNot% be consecutive.” Such parameters as %Condition% and %TimeInterval% are configurable and programmable. In one embodiment, these parameters may be implemented using web-based GUI 38.

Copy events filter 89 implements the following natural language description of its function: “If event matches %Condition%, copy event to %DestinationName%.” Again, such parameters as %Condition% and %DestinationName% are configurable and programmable by a user. In the depicted example, both copy events filter 89 and copy events filter 91 copy an event to a specified destination if a specified condition is satisfied. In this case, copy events filter 89 copies an event to SNMP destination 95. Likewise, copy events filter 91 copies an event to archive destination 97. Similarly, in this example, match sequence filter is shown writing an event to a SysLog destination 93 as one of a list of predetermined functions of its %ActionList% parameter.

As a next step, archive destination 97 serves to write the sent events from copy events filter 91 to an archive log file. Similarly, SNMP destination 95 sends SNMP trap messages, which have been converted to an internal XML representation, to a pre-specified host on a pre-specified port number using a pre-specified Community parameter. SysLog destination 93 sends SysLog messages, which have been converted to an internal XML representation, to a pre-specified host on a pre-specified port number. To accomplish the routing of such processed internal event streams back into the outside world, ECA example 79 translates the internal XML representation of each event back to its original protocol. For example, incoming SysLog messages are converted to an internal XML representation, processed, converted back to SysLog protocol, and finally, routed to a SysLog destination.

ECA 78 may be realized in a number of implementations and configurations. In one embodiment, ECA 78 becomes a physically independent, individually publishable component, with features unique to the individual user who configured them. Such an ECA may be embodied in a compact-disc or other computer program product medium, or may simply be electronically packaged for delivery across the world-wide-web.

In one embodiment, ECA 78 may be encrypted, whereby its content is no longer readable and cannot be reverse engineered. This feature may be important to users who wish to protect the originality that they may incorporate into an individual ECA 78 that is tailored for their specific applications.

In another embodiment, a license ID may be associated with an ECA 78. This feature may allow ECA 78 to be separately and independently registered. ECS 14 could create a license key for the specific license ID, to allow integration into ECS 14. Such licensing management functions again could be performed through licensing management module 68 and sent through license server 42. As such, and through such a system, ECS 14 could allow and enable the operation of an ECA 78 executing on an ECS 14 based on use of the respective license ID and license key.

In one embodiment, ECA 78 may include means to mark system objects (sources, filters, destinations), groups of system objects (such as stacks of filters), and individual parameters with (1) an enable/disable flag to turn the operation on/off inside ECS 14, (2) a lock flag which hides and makes the definitions unchangeable by the user, and (3) a prompt which asks the user to enter configuration information.

In another embodiment, ECA 78 may include the ability for a user to decrypt its contents, modify and view only unlocked components, and re-encrypt its contents and save it to a file. Such functionality will be discussed in more detail below.

In another embodiment, ECA 78, operating in conjunction with web-based GUI 38, may include the ability to associate wizard screen information with a specific parameter, such as screen sequence numbers and descriptive information. Additionally, the ability to present a set of wizard configuration screens to the user based on wizard screen information, allowing the user to change parameters, may be included. Again, such additional functionality will be discussed in more detail below.

Because the core architecture of ECS 14 allows for flexibility in its implementation, ECS 14 can be configured, or “clustered” in a variety of applications and settings. Event generators are referred to as “producers” of events. Event users or destinations are referred to as “consumers” of events. ECS 14 can be implemented in a variety of event producing and event consuming configurations, involving one or more computers. In addition, ECS 14 itself can act as a producer or/and consumer of events.

Referring to FIG. 12a, a producer and consumer configuration embodiment of ECS 14 on the same computer 92 is depicted. In the depicted embodiment, two connected ECS 14 are shown. Two connected event producers 94 are depicted sending an event stream in its associated protocol 96 to connected event correlation systems 14. Protocol 96 could be one of many protocols, such as SNMP, UDP, TCP/IP, syslog, simple text, or simply an email. Connected event correlation systems 14 first translate the event protocol into a common internal event protocol, which in one embodiment is an internal XML representation. Next, connected ECS 14 systems perform a routine of predefined tasks on event stream/protocol 96, such as examples that have been previously illustrated. In one embodiment, ECS 14 may convert from one event protocol to another, or it may convert the event from its internal, common protocol representation to one of an available plurality of protocols. ECS 14 may route an event stream 96 based on its incoming or exiting protocol. The embodiment depicted in FIG. 12a depicts connected ECS 14 as forwarding event stream/protocol 96 to connected event consumers 98. Again, in one embodiment, ECS 14 may treat event consumers 98 as a “destination”. It should be noted that, although only two ECS 14, event producers 94 and event consumers 98 are shown, more producers, consumers and event correlation systems may be accommodated using any of the above configurations.

Referring now to FIG. 12b, a multi-computer configuration is depicted. In the depicted embodiment, three physically distinct computers 92 are seen connected in a network. Two or more connected producers 94 are seen sending event stream/protocol 96 to two connected ECS 14 located on another computer 92. Once event stream/protocol 96 is processed, ECS 14 forward it again to a separate computer 92 where it is received by two connected event consumers 98.

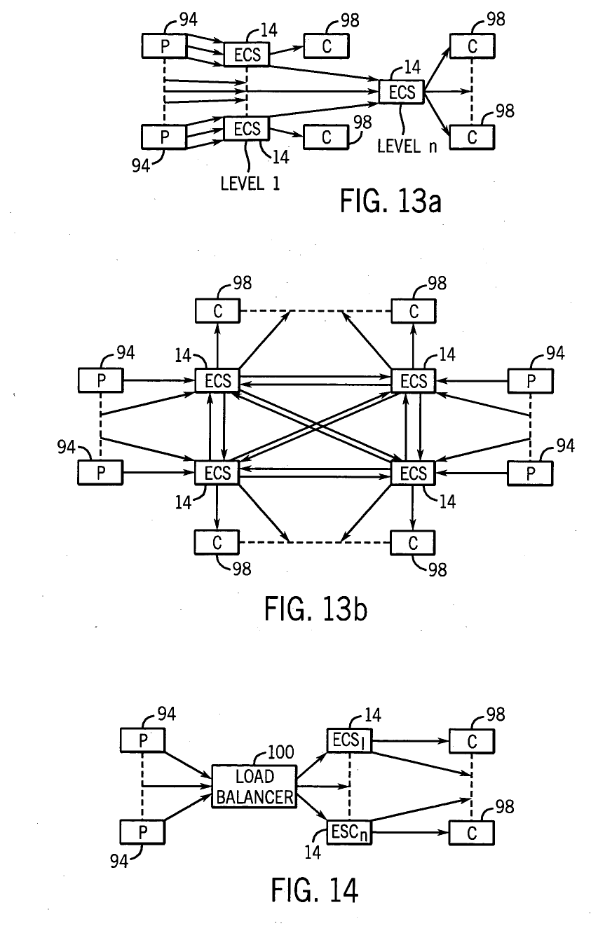

Referring to FIG. 13a, a possible hierarchical configuration of ECS 14 is shown. Event producers 94 are shown sending event streams/protocols to connected ECS 14, which constitute level 1 of the hierarchical configuration. Again, any number of ECS 14 may be realized in a hierarchical configuration. Once an event stream has been processed through level l's ECS, it may be forwarded to end event consumers 98, or it may be routed to another level of event processing. FIG. 13a depicts such forwarding to level n, after which event streams are forwarded to end consumers 98. Depending upon the resources needed, a multi-level ECS network can be developed to stagger event correlation and allocate computing resources most efficiently. Levels 1-n can be organized according to geographical proximity, network proximity, administrative responsibility, security domains, application organization or other function organization.

Referring now to FIG. 13b, a possible network graph configuration of ECS 14 is depicted. Here, event producers 94, event consumers 98, and ECS 14 are arranged in a possible network. In the depicted embodiment, ECS 14 are centrally located, with event producers 94 and event consumers 98 closer to the network's periphery. FIG. 13b illustrates the various network configurations that ECS 14 may be arranged. Because ECS 14 have the ability to cross-communicate, arrows are shown depicting event stream routing occurring in a cross-network arrangement. Again, such a possible embodiment may have an advantage of sharing network and computing resources and efficient allocation of those resources. For example, a world-wide organization may use ECS as subsystems on a local level to handle efficient preprocessing of event streams. These local systems then can forward processed event streams more efficiently to a larger event correlation system or system of event correlation systems that are designed to aggregate the locally preprocessed event streams and correlate on a national or international scope. Protocol translation by ECS 14 makes possible this implementation in a myriad of networking and hierarchical configurations.

Referring now to FIG. 14, a possible load balancing configuration of ECS 14 is shown. Again, two or more connected event producers 94 are shown delivering event stream/protocol to a load balancer 100. Load balancer 100 may comprise a computer, series of computers or network of computers that are designed to detect or monitor event streams. Load balancer 100 efficiently sends event streams to ECS 14 that is prepared and most able to receive them. Load balancer 100 can distribute the event load according to protocols, event types, functional needs, availability of processing resources of an individual ECS, availability of network bandwidth to an individual ECS, or in a round-robin load distribution. FIG. 14 depicts a series of ECS 14 labeled ECS₁ to ECSₙ that receive routed event streams from load balancer 100. Again, depending upon network resources, topography and complexity, event correlation systems can be arrayed as needed to process incoming event streams and efficiently route them to event consumers 98 at various destinations.

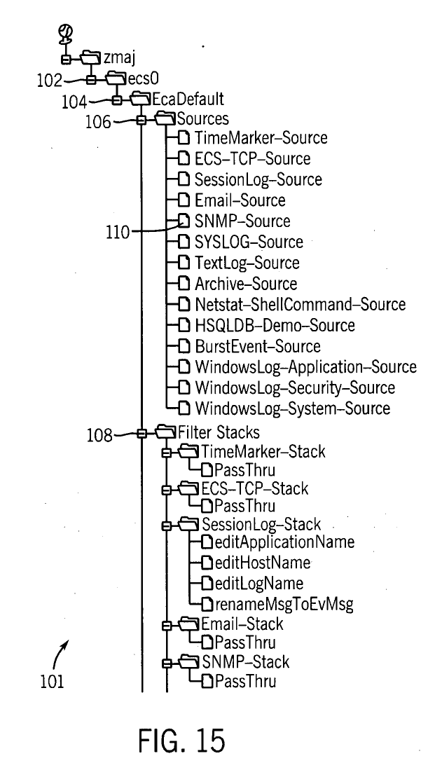

Referring now to FIG. 15, an illustration of a segment of web-based graphical user interface 38 is depicted in a possible embodiment. Tree and tabular display 101 depicts an event correlation system as “ecs0” 102. Ecs0 102 is shown in an open folder configuration, with “EcaDefault” 104 making up one of its respective subfolders. EcaDefault 104 is an embodiment of ECA 78. The contents of EcaDefault 104 are displayed in a tree configuration. The first component of EcaDefault 104 is sources category 106. Sources 106 is also displayed in an open folder configuration, with various defined sources shown, such as “Email” source file 110. Additionally, “FilterStacks” category 108 is depicted with associated subfolders. Not shown, but similarly situated, is a destinations category with associated subfolders.

In one embodiment, tree and tabular display 101 includes selectable nodes with respective links. For example, a user could click on Email source file 110 to view additional descriptive and configurative information about the respective source.

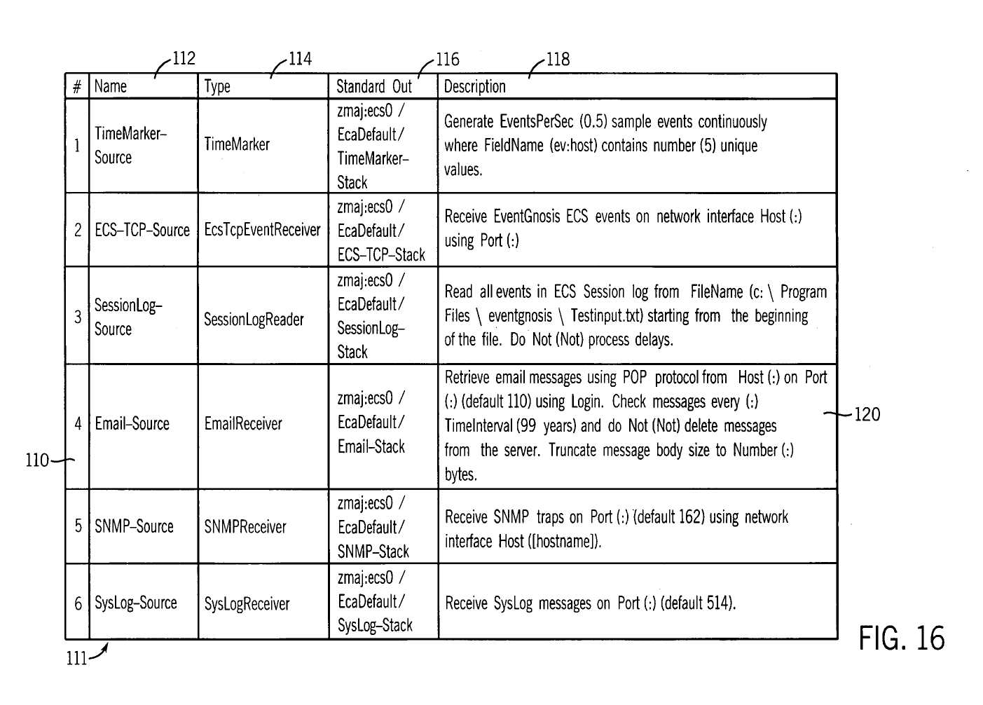

Referring to FIG. 16, table layout 111, another segment of web-based graphical user interface, is depicted in a possible embodiment. Table layout 111 is organized in the same configuration as tree and tabular display 101, that being in terms of sources, filters and destinations. Name category 112, type category 114, standard out category 116 and description category 118 are depicted. Name category 112 simply displays the respective source, filter/filter stack or destination by name. Type category 114 provides more identifying information, specifically the respective system object. Standard out category 116 describes the address of the respective source or filter stack as a whole or destination in the system. For filters, standard out category 116 implicitly describes the next filter in the stack. If the last filter in the stack is reached, then standard out category 116 reflects the standard out for the entire filter stack. Adjacent to standard out category 116, description category 118 is shown. Description 118 displays and provides a natural language description for the respective source, filter/stack or destination.

In one embodiment, web-based GUI 38 presents the user with a natural language description 118 that contains configurable parameters as selectable links for the system objects of ECA 78. Further, upon user selection of a respective parameter, a configuration screen is presented which allows the user to modify the parameter configurations. GUI 38 may provide a summary of the content of these parameter configurations, with each parameter described in a natural language definition of ECA system objects.

In one embodiment, GUI 38 may automatically generate summary content, or more particularly, automatically generate summary content of complex parameters in natural language form.

To illustrate the natural language parameter editing and summarizing functionality of GUI 38, email source 110 is depicted in table layout 111 as shown in FIG. 16. Email source 110 is depicted as type “EmailReceiver”, again referring to the respective ECA system object. Natural language description 120 describes the functionality of this respective source. In this embodiment, email source 110 retrieves email messages using POP protocol from a particular host an a particular port using a defined login script. The source checks messages on a particular time interval and may delete these messages from the server. Finally, messages may be truncated in size to a particular number of bytes.

In this example, parameters “Host”[ ], “Port”[ ], “Login”, “TimeInterval”[ ], “do Not (Not) delete messages” and “Number”[ ] are all editable and configurable parameters of email source 110. In one embodiment, each configurable parameter is selectable and editable. A user has the flexibility to specifically configure each respective parameter, again in the context of natural language description 118. A configuration screen may be presented upon selection of a particular parameter, allowing the user to modify any or all of the respective parameters.

Again, in the previous example, a source was described and depicted. Filter/Filter stacks and destinations may also be ordered, displayed, editable and configurable in the same manner.

In another embodiment, GUI 38 may include a debugger which enquires and displays run-time status information of system objects. The debugger may allow a user to insert or trace an event through ECS 14. Further, the debugger may allow a user to use tools to correct malfunctioning or inoperable components of ECS 14 or a particular system object.

ECAs 78 have been described as highly decoupled from ECS 14. The individual configurability of an ECA allows for additional functionality in its implementation. In one embodiment, an individually configured ECA may contain encrypted information that can be individually saved to a file. Moreover, such an application has been described as individually and independently publishable.

As a result, a number of implementations of an ECA 78 can be realized. Furthermore, ECAs can be realized in particular business methods of a user that desires to market the individual functionality of each respective application. The following steps may be realized in the implementation of a business method using event control applications. In one embodiment, this business method may be implemented on an eCommerce website. First, the ECA may be listed on a web catalog by a respective developer. Secondly, the ECA may be uploadable or uploaded to the web catalog by a developer. As a next step, the respective ECA may also be downloadable or downloaded from the web catalog by an end user. A developer may, as a next step, issue a license key to the end user to use the respective ECA in the end implementation. The end user then runs the ECA in its end implementation. Finally, the developer may receive payment from the end user.

ECAs may also be implemented in a business method by either independent software vendors (ISVs) or original equipment manufacturers (OEMs), by accomplishing the following: First, a rightholder may enable others to package their domain expertise into an ECA that reflects this individual functionality. Secondly, this rightholder may enable an OEM/ISV to sell license ID/license key protected ECAs. These ECAs may be distributed using a predetermined license key or vendor ID distribution model. As a next step, a rightholder may allow an OEM the ability to embed, label, package and protect an ECA to the OEM's specifications. In exchange, the rightholder may receive payments or royalties for such things as source code licenses or sales of ECAs.

An ECA 14 or system of ECAs 14 with their corresponding ECAs 78 may be used to solve event management problems in one or more of the following market segments: (1) security management, (2) network management, (3) application management, (4) system management, (5) services management; (6) user management, (7) telephony management, (8) Voice-over-IP (VOIP) management, (9) wireless communication management, (10) military information management, (12) enterprise and business process management, (13) regulatory compliance management, (14) financial information management, (15) the control and management of classified environments, (16) homeland defense, (17) government information management and (17) law enforcement.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of configuring an event correlation system, comprising:
routing an event stream received from an input of the event correlation system to a filter;
processing the event stream through a first correlation algorithm within the filter to provide a correlated output stream, wherein the first correlation algorithm is configurable in response to a first configuration control instruction; and
routing the correlated output stream to an output of the event correlation system.

2. The method of claim 1, further providing a configuration file which contains the first configuration control instruction.

3. The method of claim 1, wherein routing the event stream received from an input of the event correlation system to a filter which is configurable by a second configuration control instruction.

4. The method of claim 1, wherein routing the correlated output stream to an output of the event correlation system is configurable by a second configuration control instruction.

5. The method of claim 1, wherein the first correlation algorithm further includes:
assigning the filter a name;
associating a natural language description of the first correlation algorithm; and
defining a configurable parameter of the filter.

6. The method of claim 2, further including:
encrypting the configuration file whereby its content is no longer readable and cannot be reverse engineered;
associating a license key or license ID with the configuration file;
enabling operation of the configuration file in the event correlation system using the license key or license ID.

7. The method of claim 2, further including registering objects for use in the event correlation system.

8. The method of claim 2, further including using an object library or class to implement said method.

9. The method of claim 1, further including marking an object, a group thereof, or an individual parameter with:
an enable/disable flag to turn an operation on/off inside the event correlation system;
a lock flag which hides and makes the object, group thereof, and individual parameter unchangeable by the user; and
a prompt which asks a user to enter information to configure the event correlation system.

10. A method of providing an event correlation system which can be integrated into a software system, comprising:
providing a source module for routing an event stream received from an input of the event correlation system;
providing a filter module for processing the event stream through a first correlation algorithm, the filter module being configurable to operate with the software system; and
providing a destination module for routing a correlated output stream from the filter module to an output of the event correlation system.

11. The method of claim 10, further providing a configuration file which contains the filter module.

12. The method of claim 10, further providing an interface which integrates the filter module into the event processing system.

13. The method of claim 10, further providing an object library or class to implement said method.

14. The method of claim 10, further providing a system which can be integrated into a software system to register the filter module for operation in the event correlation system.

15. The method of claim 10, further providing:
an encryption method to encrypt the filter module or configuration module; and
a license key or license ID which is associated with the filter module or configuration module.

16. A method of processing an event stream into a correlated output, comprising:
providing a source module to receive the event stream and route the event stream to a filter module; and
configuring the filter module to process the event stream through a first correlation algorithm to provide the correlated output, the filter module being configurable in response to a first configuration instruction.

17. The method of claim 16, further including providing a destination module to route the event stream to a destination.

18. The method of claim 16, further including configuring the filter module by associating a natural language description of the first configuration instruction with the filter module.

19. The method of claim 16, further including configuring the filter module using an object library or class to implement said method.

20. The method of claim 16, further including:
encrypting the first configuration instruction whereby its content is no longer readable and cannot be reverse engineered; and
associating a license key or license ID with the first configuration instruction or the filter module;

21. The method of claim 20, further including:
decrypting the first configuration instruction using the license key or license ID;
modifying or viewing the unlocked components of the first configuration instruction; and
saving the first configuration instruction to a file.

22. A computer program product comprising a computer usable medium having computer readable program code means embodied in said medium for causing an application program to execute on a computer that provides an event correlation system, said computer readable program code comprising:
a first computer readable program code means for routing an event stream received from an input of the event correlation system to a filter;
a second computer readable program code means for processing the event stream through a first correlation algorithm within the filter to provide a correlated output stream, wherein the first correlation algorithm is configurable in response to a first configuration control instruction; and
a third computer readable program code means for routing the correlated output stream to an output of the event correlation system.

23. The computer program product of claim 22, further including a configuration file which contains the first configuration control instruction.

24. The computer program product of claim 22, further including a second configuration control instruction which configures the routing of an event stream received from an input of the event correlation system to a filter.

25. The computer program product of claim 22, wherein the first correlation algorithm further includes:
a first computer readable program code means for assigning the filter a name;
a second computer readable program code means for associating a natural language description of the algorithm; and
a third computer readable program code means for defining a configurable parameter of the filter.

26. The computer program product of claim 22, wherein the event correlation system includes a first computer readable program code means for using an object library or class to implement a function of the event correlation system.

27. The computer program product of claim 22, further including:
a first computer readable program code means for encrypting the first configuration instruction whereby its content is no longer readable and cannot be reverse engineered; and
a second computer readable program code means for associating a license key or license ID with the first configuration instruction.

28. The computer program product of claim 27, further including:
a first computer readable program code means for decrypting the first configuration instruction by the license key or license ID;
a second computer readable program code means for modifying and viewing the unlocked components of the first configuration instruction; and
a third computer readable program code means for saving the first configuration instruction to a file.
